(19) United States
(12) Patent Application Publication
(10) Pub. No.: US 2023/0383023 A1
(43) Pub. Date: Nov. 30, 2023

(54) ORGANOMETALLIC CATALYSTS AND METHODS OF MAKING AND USING THE SAME

(71) Applicant: UNIVERSITY OF HOUSTON SYSTEM, Houston, TX (US)

(72) Inventors: Eva Harth, Houston, TX (US); Yu-Sheng Liu, Rahway, NJ (US)

(21) Appl. No.: 18/319,688

(22) Filed: May 18, 2023

Related U.S. Application Data
(60) Provisional application No. 63/343,341, filed on May 18, 2022.

(51) Int. Cl. C08F 10/02

(52) U.S. Cl. CPC C08F 10/02

(57) ABSTRACT

A catalyst having a structure according to Formula (1):

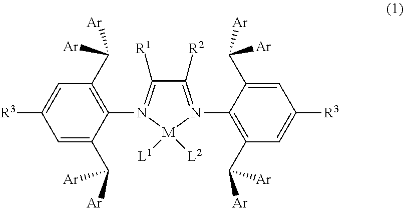

wherein R¹ and R² are each independently selected from aliphatic groups, substituted or unsubstituted phenyl groups and silyl groups, or R¹ and R² are bonded together in the form of a cycloalkane, each R³ is hydrogen, an aliphatic group or a halogen, each Ar group is a meta-substituted phenyl group, a para-substituted phenyl group or a meta- and para-substituted phenyl group, M is a transition metal and L¹ and L² are each independently methyl, Cl, Br, NCCH₃, DMSO, or L¹ and L² are bonded together in the form of a bidentate ligand.

### CROSS REFERENCE TO RELATED APPLICATION

This application claims the benefit of U.S. Provisional No. 63/343,341 filed May 18, 2022, the entire contents of which are incorporated by reference herein.

### FIELD OF THE INVENTION

The present invention relates to organometallic catalyst complexes having α-diimine ligands and methods of making and using said catalysts complexes. More specifically, the present invention relates to new and inventive organometallic catalyst complexes having α-diimine complexes and their use a polymerization catalyst from the fabrication homopolymers, copolymers and block copolymers.

### BACKGROUND OF THE DISCLOSURE

Research directed to α-diimine Ni^{II} and Pd^{II} complexes has been of interest due to their potential as catalysts that perform polymerization of olefins as well as polar monomers that are known to poison other catalysts such as Ziegler-Natta/metallocene catalysts. Some have sought to modify the α-diimine ligand structure in such catalysts with the goal of tailoring polar monomer incorporation during polymerization reactions as well as the microstructure of the resulting polymer. The addition of steric bulk to the axial sides of α-diimine ligands for use in such catalysts has inspired several complex designs. Prior studies have indicated higher axial shielding can lead to retardation of chain-transfer relative to the rate of coordination polymerization, and living polymerization and high molecular weight polymers can be obtained under much improved thermal stability. Furthermore, prior studies have indicated that the chain-walking ability of such catalysts can be increased by decreasing ethylene trapping, as trapping and insertion are competitive with chain-walking, leading to highly branched polyolefins.

In one study, a sandwich-type α-diimine Pd^{II} complex (Complex A) was shown to produce a polyethylene polymer with a higher degree on branching (110-120/1000 C) than a polyethylene polymer produced from non-sandwich-type α-diimine Pd^{II} complex (Complex B); 95-100/1000 C). In addition, the sandwich-type complex A exhibited narrow dispersity (M_{w}/Mₙ<1.1), indicative of living polymerization.

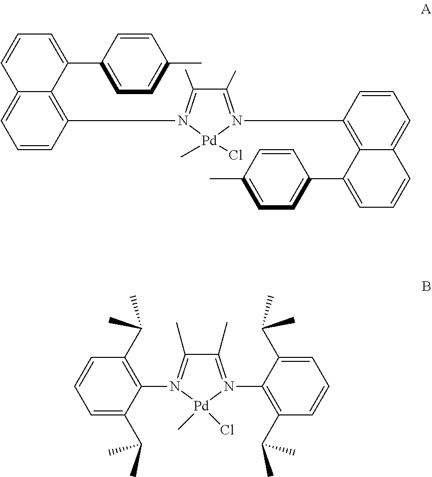

In another study, a ridged axial protective framework of a α-diimine Pd complex with a dibenzobarrelene backbone (Complex C) exhibited prevented associative displacement chain-transfer to produce an unexpectedly ultrahigh branched polyethylene polymers (220/1000 C) containing mostly methyl branches.

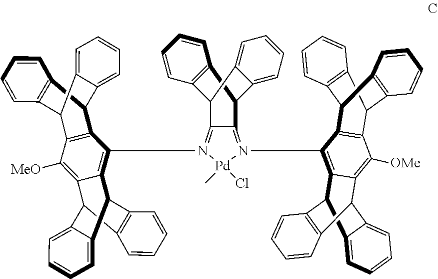

In another study, α-diimine Pd Complex D was found to exhibit axial blockage that could not only reduce the usual preference for ethylene but significantly increase the incorporation of polar monomers.

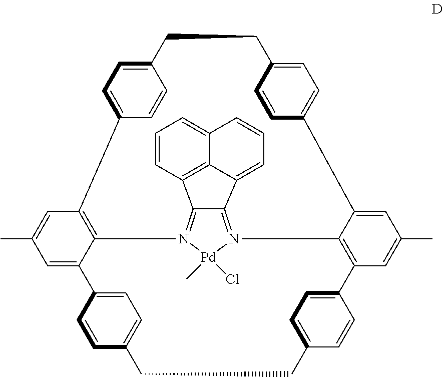

In yet another study, researchers developed α-diimine Pd complexes having phenyl or naphthyl groups at the ortho N-aryl position (Complex E). Complex E catalysts were shown to produce a polyethylene polymer with high molecular and relatively low branching (20-29/1000 C), demonstrating that the addition of steric bulk to the diimine ligands can be used as a means to gain access to a broader range of polymeric branching density and resulting in highly amorphous to semi-crystalline polymers.

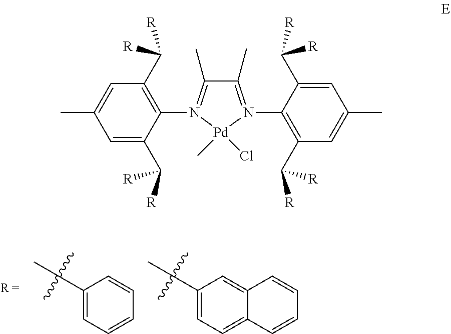

To date, however, the art does not appear to recognize the types of steric and design features of α-diimine ligands that are key factors in axial shielding to reduce the formation of polyethylene polymers exhibiting high degrees of branching.

### SUMMARY OF THE DISCLOSURE

In this accordance with various aspects of the disclosure, novel organometallic α-diimine catalysts complexes are provided herein. Novel organometallic α-diimine catalyst complexes according to various aspects of the disclosure exhibit the presence of steric bulk positioned at ortho N-aryl substituents of the α-diimine ligand, which can promote axial shielding of the catalyst complex metal center to attain living polyethylene (PE) with low degrees of branching and thus high linearity. Novel organometallic α-diimine catalysts complexes according to various aspects of the disclosure rely in part upon the presence of steric rotation barriers rather than generic ligand bulk to result in more effective and stable shielding effects of the catalyst complex metal center, enabling ethylene trapping while also maintaining the ability to retard the chain-transfer. The α-diimine ligands presented herein preserve living polymerization without lowering the activity of the catalyst or slowing down the rate of insertion, leading to limited chain-walking which results in semi-crystalline PE with high molecular weight.

The expansion of known organometallic α-diimine catalyst complexes to produce semi-crystalline polyethylene is most valuable as the desired properties of polyethylene stem mostly from its toughness and capability to organize into microdomains. For example, the application of semi-crystalline polyethylene as part of block copolymer architectures is very attractive as the non-polar block asserts properties which polyacrylates alone are unable to achieve and vice versa. In previous work, we have developed a one-step procedure of preparing polyolefin-polyacrylate copolymers called metal-organic insertion light-initiated radical (MILRad) polymerization to join the complementary properties of these two monomer families. In a MILRad polymerization, a single catalyst accomplishes both the insertion and radical polymerization, avoiding multistep synthesis and post-functionalization, and prevents homopolymers from being generated during the radical polymerization. This technique has employed a cationic palladium(II) diimine catalyst that polymerizes olefins in a living coordination-insertion manner (Ð<1.1). A polyolefin macroradical is generated through blue light irradiation, which undergoes free radical polymerization in the presence of vinyl monomers. MILRad polymerization is a facile method for generating polar-polyolefin block copolymers.

As block copolymers retain the features of each individual block, the combination of semi-crystalline polyethylene and polyacrylates produced from a range of different acrylic monomers can exhibit different mechanical properties. To accomplish this goal, polyolefin-polyacrylate copolymers are provided herein that show a high stability at ambient temperature and provide a living behavior for MILRad polymerization. Moreover, a high molecular weight polyethylenes with linear microstructures are desirable to gain access to novel high molecular weight polyethylene/polyacrylate and polyethylene/polymethacrylate copolymers and diblock copolymers with advantageous properties.

Organometallic α-diimine catalyst complexes are presented herein which include meta- and/or para-functional groups at benzhydryl substituents on the diimine backbone. These groups provide an effective rotation barrier and can result in sandwich-type catalysts with distorted square planar geometries at the metal center.

Using polymerization catalysts according to various aspects of the disclosure, high molecular weight polyethylene (PE) with good linearity is accomplished by polymerization of ethylene at low pressures and temperatures up to 80° C. Also using polymerization catalysts according to various aspects of the disclosure, copolymerization of ethylene and acrylates/methacrylates gave further insight into the extend of the metal center shielding and differences resulting from the ligand design. MILRad polymerizations using catalysts according to various aspect of the disclosure give a range of high molecular weight block copolymers with hard and soft, thermoplastic properties that can be tailored by way of the acrylic block.

In accordance with various aspects of the disclosure, a first embodiment is a catalyst having a structure according to Formula (1):

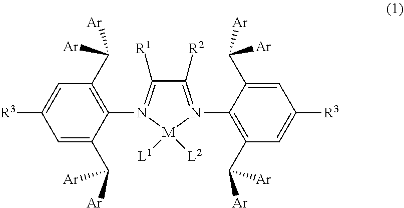

wherein R¹ and R² are each independently selected from aliphatic groups, substituted or unsubstituted phenyl groups and silyl groups, or Rand R² are bonded together in the form of a cycloalkane; each R³ is hydrogen, an aliphatic group or a halogen; each Ar group is a meta-substituted phenyl group, a para-substituted phenyl group or a meta- and para-substituted phenyl group; M is a transition metal; and L¹ and L² are each independently methyl, Cl, Br, NCCH₃, DMSO, or L¹ and L² are bonded together in the form of a bidentate ligand.

In accordance with various aspects of the disclosure, a second embodiment is a catalyst according to the first embodiment, wherein each Ar group has a structure according to Formula (2):

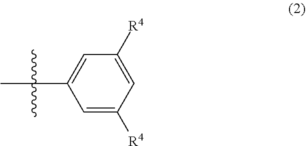

wherein each R⁴ is methyl, tert-butyl, trifluoromethyl, F, or nitrile.

In accordance with various aspects of the disclosure, a third embodiment is a catalyst according to the second embodiment, wherein each R⁴ is methyl.

In accordance with various aspects of the disclosure, a fourth embodiment is a catalyst according to the first embodiment, wherein each Ar group has a structure according to Formula (2):

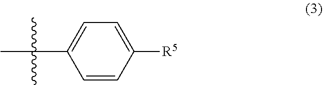

wherein each R⁴ is methyl, ethyl, propyl, isopropyl, butyl, tert-butyl, pentyl, vinyl, ethynyl, 1,1-diofluoroethyl, —CH₂NHCH₃, a benzyl group, trifluoromethyl, trimethylsilyl, ethynyltrimethylsilane, a piperidinyl group, or a morpholino group.

In accordance with various aspects of the disclosure, a fifth embodiment is a catalyst according to the fourth embodiment, wherein each R⁵ is methyl.

In accordance with various aspects of the disclosure, a sixth embodiment is a catalyst according to the first embodiment, wherein each Ar group is 3,4,5-trimethylbenzene, 3,4,5-trifluorobenzene, 4-amino-3,5-dimethylbenzene, 4-amino-3,5-diethylbenzene, or 4-amino-3,5-difluorobenzene.

In accordance with various aspects of the disclosure, a seventh embodiment is a catalyst according to any one of the first through sixth embodiments, wherein L¹ is methyl and L² is Cl or L¹ is Cl and L² is methyl.

In accordance with various aspects of the disclosure, an eighth embodiment is a catalyst according to any one of the first through seventh embodiments, wherein M is Pt, Pd, Ni, Rh, Ti and Ir.

In accordance with various aspects of the disclosure, a ninth embodiment is a catalyst according to any one of the first through eighth embodiments, wherein M is Pd(II) or Ni(II).

In accordance with various aspects of the disclosure, a tenth embodiment is a catalyst according to any one of the first through ninth embodiments, wherein M is Pd(II).

In accordance with various aspects of the disclosure, an eleventh embodiment is a composition comprising a catalyst according to any one of the first through tenth embodiments and a catalysis promoting salt.

In accordance with various aspects of the disclosure, a twelfth embodiment is a composition comprising a catalyst according to the eleventh embodiment, wherein the catalysis promoting salt is sodium tetrakis[3,5-bis(trifluoromethyl)phenyl]borate (NBArF) or lithium tetrakis(pentafluorophenyl)borate.

In accordance with various aspects of the disclosure, a thirteenth embodiment is directed to a method of forming a polyethylene (PE), the method comprising reacting ethylene monomers with a catalyst according to any one of the first through tenth embodiments.

In accordance with various aspects of the disclosure, the fourteenth embodiment is directed to a method of forming a polyethylene (PE), the method comprising reacting ethylene monomers with a composition according to the eleventh or the twelfth embodiment.

In accordance with various aspects of the disclosure, a fifteenth embodiment is directed to a method of forming a polyolefin (PO), the method comprising reacting one or more olefin monomers with a catalyst according to any one of the first through tenth embodiments.

In accordance with various aspects of the disclosure, a sixteenth embodiment is directed to a method of forming a polyolefin (PO), the method comprising reacting one or more olefin monomers with a composition according to the eleventh or the twelfth embodiment.

In accordance with various aspects of the disclosure, a seventeenth embodiment is directed to a method of forming a polyethylene/olefin copolymer (P(E-co-O)), the method comprising reacting ethylene monomers and one or more olefin monomers with a catalyst according to any one of the first through tenth embodiments.

In accordance with various aspects of the disclosure, an eighteenth embodiment is directed to a method of forming a polyethylene/olefin copolymer (P(E-co-O)), the method comprising reacting ethylene monomers and one or more olefin monomers with a composition according to the eleventh or the twelfth embodiment.

In accordance with various aspects of the disclosure, a nineteenth embodiment is directed to a method of forming a polyethylene/acrylate copolymer (P(E-co-Acrylate)) or a polyethylene/methacrylate copolymer (P(E-co-Methacrylate)), the method comprising reacting ethylene monomers and one or more acrylate monomers or one or more methacrylate monomers with a catalyst according to any one of the first through tenth embodiments.

In accordance with various aspects of the disclosure, a twentieth embodiment is directed to a method of forming a polyethylene/acrylate copolymer (P(E-co-Acrylate)) or a polyethylene/methacrylate copolymer (P(E-co-Methacrylate)), the method comprising reacting ethylene monomers and one or more acrylate monomers or one or more methacrylate monomers with a composition according to the eleventh or the twelfth embodiment.

In accordance with various aspects of the disclosure, a twenty-first embodiment is directed to a method of forming a polyolefin/acrylate copolymer (P(O-co-Acrylate)) or a polyolefin/methacrylate copolymer (P(O-co-Methacrylate)), the method comprising reacting olefin monomers and one or more acrylate monomers or one or more methacrylate monomers with a catalyst according to any one of the first through tenth embodiments.

In accordance with various aspects of the disclosure, a twenty-second embodiment is directed to a method of forming a polyolefin/acrylate copolymer (P(O-co-Acrylate)) or a polyolefin/methacrylate copolymer (P(O-co-Methacrylate)), the method comprising reacting olefin monomers and one or more acrylate monomers or one or more methacrylate monomers with a composition according to the eleventh or the twelfth embodiment.

### BRIEF DESCRIPTION OF THE DRAWINGS

FIG. 1 is a non-exclusive and exemplary reaction scheme for the synthesis of polyethylene (PE) and polyethylene/polyacrylate (PA) diblock copolymers (PE-b-PA) using catalysts according to various aspects of the disclosure.

FIG. 2 is an exemplary reaction scheme for the synthesis of catalyst complexes 1 and 2 according to various aspects of the disclosure.

FIG. 3 is an X-ray crystallographic structure of catalyst complex 1 (hydrogen atoms are omitted for clarity and thermal ellipsoids are set at 50% probability; selected bond distances [Å] and angles [°]: Pd1-Cl1 2.3022(5), Pd1-C87 2.0762(19), Pd1-N1 2.1394(17), Pd1-N2 2.0467(17), N1-C46 1.433(3), N2-C3 1.446(3); N1-Pd1-N2 77.42(7), N1-Pd1-Cl1 98.52(5), N2-Pd1-C87 97.06(7)).

FIG. 4 is an X-ray crystallographic structure of catalyst complex 1 (hydrogen atoms are omitted for clarity and thermal ellipsoids are set at 50% probability; selected bond distances [Å] and angles [° ]: Pd(1)-Cl(1′)=2.248(14), Pd(1)-C(40′)=2.02(3), Pd(1)-N(1)=2.059(3), Pd(1)-N(2)=2.131(2), N(1)-C(20)=1.454(4), N(2)-C(41)=1.444(4), N(1)-Pd(1)-N(2)=76.82(10), N(1)-Pd(1)-Cl(1′)=106.2(4), N(2)-Pd(1)-C(40′)=95.1(18)).

FIG. 5 shows a steric map of catalyst complex 1.

FIG. 6 shows a steric map of catalyst complex 2.

FIG. 7 shows a space-filling model of catalyst complex 1.

FIG. 8 shows a space-filling model of catalyst complexes 2.

FIG. 9 is a simplified reaction scheme for the synthesis of PA-b-PA diblock copolymer copolymers.

FIG. 10 is exemplary reaction scheme for the synthesis of a PE-b-P(MA-co-NAS) diblock copolymer and subsequent reaction with 1-pyrenemethylamine to result in a fluorescent PE-b-P(1-pyrenemethylamide)-type diblock copolymer.

### DETAILED DESCRIPTION

The following description of the embodiments is merely exemplary in nature and is in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, and alternatively ±1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s) but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

In accordance with various aspects of the disclosure, organometallic catalyst complexes having α-diimine ligands that include meta- and/or para-functional groups at benzhydryl substituents on the diimine backbone are presented herein. Catalyst complexes according to various aspects of the disclosure can be described as having a general formula according to Formula 1:

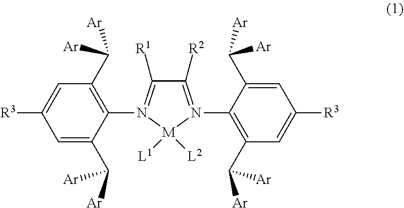

As can be seen, the α-diimine ligand according to formula 1 includes groups R¹ and R². In some instances, one or both of R¹ and R² are an aliphatic group such as methyl, ethyl, n-butyl, t-butyl, or a C₃-C₇ linear or branched alkene. In some instances, one or both of R¹ and R² are a substituted or unsubstituted phenyl group. In some instances, one or both of R¹ and R² are a silyl group such as a trimethylsilyl, a dimethylsilyl, a triethylsilyl or a diethylsilyl. In some instances, R¹ and R² have the same chemical structure such that the N=C(R¹)—C(R²)=N portion of the α-diimine ligand is symmetrical. In some instances, R¹ and R² have different chemical structures such that the N=C(R¹)—C(R²)=N portion of the α-diimine ligand is asymmetrical. In some instances, R¹ and R² form a cycloalkane such as cyclopentane, cyclohexane, cycloheptane, cyclodecane or cyclododecane.

The α-diimine ligand further includes two phenyl groups, one bound to each of the imine nitrogens. Each phenyl group is substituted at the 2 (a —C(H)—(Ar)₂ benzhydryl group), 4 (—R³ group), and 6 (a —C(H)—(Ar)₂ benzhydryl group) positions. R³ can be any suitable functional group such as, for example, a hydrogen, an aliphatic group (for example, methyl, ethyl, propyl, isopropyl, butyl, tertbutyl, and so on) or a halogen. Preferably, each R³ has the same chemical structure. In some instances, catalysts according to Formula 1 preferably have a methyl group for each R³. Generally, the structure of R³ can be chosen by one of ordinary skill in the art in view of common organic synthetic principles related the synthesis of α-diimine ligands and their precursors.

In some instances, each Ar group of the benzhydryl substituents is a phenyl ring substituted at both meta (i.e., 3 and 5) positions and exhibits a structure according to Formula 2:

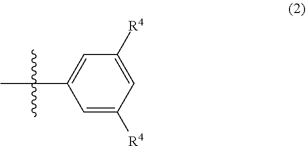

Suitable R⁴ groups include, but are not limited to, methyl, tert-butyl, trifluoromethyl, fluoro, nitrile, or any combination thereof. In some instances, Ar groups with each R⁴ being a methyl group are preferred in catalysts according to Formula 1.

In some instances, each Ar group is a para-substituted phenyl ring exhibiting a structure according to Formula 3:

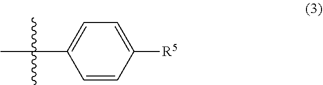

Suitable R⁵ groups include but are not limited to phenyl groups having at the para position, a methyl, ethyl, propyl, isopropyl, butyl, tert-butyl, pentyl, vinyl, ethynyl, 1,1-diofluoroethyl, —CH₂NHCH₃, a benzyl group, trifluoromethyl, trimethylsilyl, ethynyltrimethylsilane, a piperidinyl group, or morpholino group. In some instances, the use of p-methyl substituted Ar groups are preferred in catalysts according to Formula 1.

In some instances, each Ar group is a phenyl ring substituted at the meta (i.e., 4) and both para (i.e., 3 and 5) positions. Suitable meta/para-substituted Ar groups include, but are not limited to, 3,4,5-trimethylbenzene, 3,4,5-trifluorobenzene, 4-amino-3,5-dimethylbenzene, 4-amino-3,5-diethylbenzene, and 4-amino-3,5-difluorobenzene.

Coordinated to the α-diimine ligand is a metal M and its associated ligands L¹ and L². Various transition metals can be coordinated to α-diimine ligands of the disclosure. Suitable metals include, but are not limited to, Pt, Pd, Ni, Rh, Ti and Ir. In some instances, the use of Ni(II) or Pd(II) as the metal M is preferred in catalysts according to Formula 1. In some instances, the use of Pd(II) as the metal M is particularly preferred in catalysts according to Formula 1. L¹ and L² can be any suitable ligand including, but not limited to, methyl, Cl, Br, NCCH₃, DMSO. In some instances, L¹ and L² can be a single bidentate ligand such as, for example, acetylacetonate (acac), oxalate (ox), ethylenediamine (en) or cyclooctadiene (COD). In some instances, the use of a methyl and a Cl for L¹ and L² respectively, or L² and L¹ respectively, is preferred in catalysts according to Formula 1.

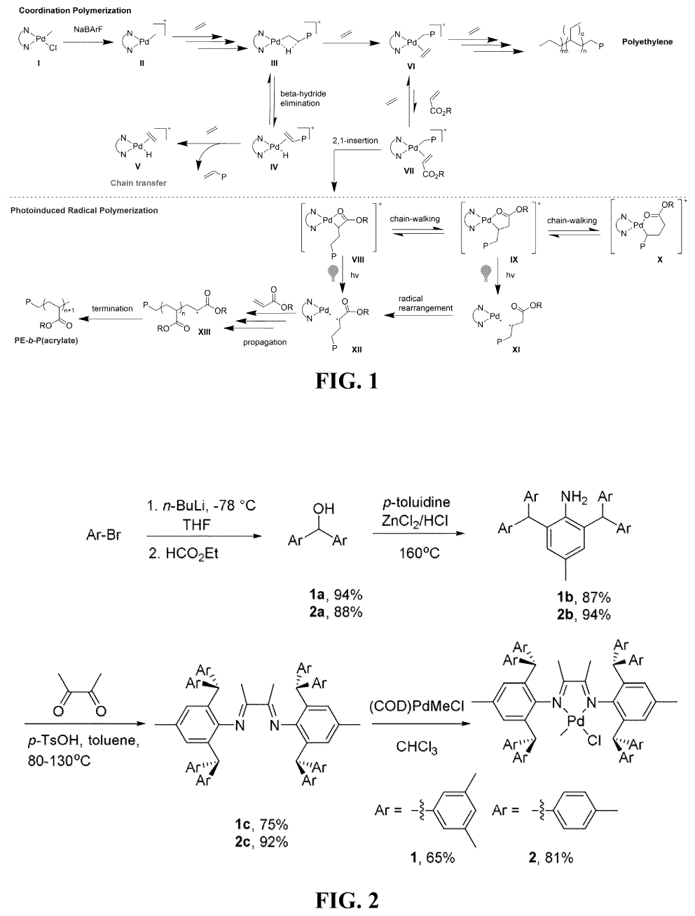

Brookhart catalysts, of which the new catalysts according to Formula 1 are structurally related, are used in the polymerization of polyethylene to generate high molecular weight polyolefins having various branched structures via a chain-walking mechanism. In the chain-walking mechanism, chain propagation, chain transfer, and chain walking or isomerization are the major mechanistic steps. During controlled chain walking polymerization, the metal atom of the catalyst migrates along the forming polymer backbone through a rapid β-hydride elimination reaction and reinsertion 2,1-insertion. Methyl and longer chain branches (for example, ethyl, n-propyl, n- and sec-butyl) are generated from ethylene trapping and insertion of the secondary metal-alkyl species. In a mechanistic study of MILRad, we proposed a mechanism for the block formation which detailed the investigation of the three critical parts of block copolymer formation: coordination-insertion polymerization, photoinitiated “switch”, and radical polymerization. The insertion pathway leading to the polyolefin block is depicted in FIG. 1. Ethylene insertion and chain-walking results in the agostic intermediate III which can either proceed to undergo β-hydride elimination IV and chain-transfer V or undergo further coordination with monomers to form complex VI to yield polyethylene. In the so called “switch” phase, an acrylic or methacrylic monomer coordinates VII and forms the macrochelates VIII, IX and X. In previous studies, we have determined the predominantly stable six-membered chelate X needs the assistance of ancillary ligands to be ring opened to form the macroradical under light irradiation. However, in none of the block formations with MILRad using certain catalysts according to various aspects of the disclosure (such as catalyst 1, described below), was the use of ancillary ligand necessary. We hypothesize that when sterically demanding catalyst complexes are used for block formation, the four-VIII and five-membered macrochelates IX are more prevalent. These chelates can undergo Pd—C bond cleavage under light irradiation to form the α-carbonyl XII and β-carbonyl macroradical XI to proceed with the free radical polymerization pathway. This updated version of the MILRad polymerizations is proposed for block copolymer syntheses that are performed with complexes having extensive axial shielding in contrast to other prior art α-diimine catalysts.

In accordance with various aspects of the disclosure, catalysts according to Formula 1 can be used in the polymerization of ethylene to form polyethylene (PE). In accordance with various aspects of the disclosure, catalysts according to Formula 1 can be used in the polymerization of higher order olefins to form corresponding polyolefins (POs). Olefins that may be polymerized by catalysts according to Formula 1 may have a linear or branched structure. Linear higher order olefins that may be polymerized by catalysts according to Formula 1 may include, but are not necessarily limited to, propylene, 1-butene, 1-hexene, 1-octene, 1-decene and 1,3-butadiene. Branched higher order olefins that may be polymerized by catalysts according to Formula 1 may include, but are not necessarily limited to, isoprene, isobutylene and 4-methyl-1-pentene. In some instances, linear or branched olefins can be used alone to form corresponding homopolymers. In some instances, ethylene and one or more olefins may be copolymerized to form ethylene/olefin (or P(E-co-O)) copolymers having varying physical and/or chemical properties. In some instances, ethylene and one or more acrylates may be copolymerized to form ethylene/acrylate (or P(E-co-Acrylate)) copolymers having varying physical and/or chemical properties. In some instances, ethylene and one or more methacrylates may be copolymerized to form ethylene/methacrylate (or P(E-co-Methacrylate)) copolymers having varying physical and/or chemical properties. In some instances, a higher order olefin and one or more acrylates may be copolymerized to form olefin/acrylate (or P(O-co-Acrylate)) copolymers having varying physical and/or chemical properties. In some instances, a higher order olefin and one or more methacrylates may be copolymerized to form olefin/methacrylate (or P(O-co-Methacrylate)) copolymers having varying physical and/or chemical properties.

Polymerization reactions in the manufacture of PE homopolymers, PO homopolymers and the above copolymers can be conducted at in an inert, and most preferably water-free, environment at temperatures ranging from about −20° C. to about 100° C., alternatively from about −10° C. to about 90° C. alternatively from about 0° C. to about 80° C. In some instances, such as when PE is to be produced, a polymerization temperature of about 40° C. results in polyethylenes having optimal properties. Polymerization reactions in the manufacture of PE homopolymers, PO homopolymers and the above copolymers can be conducted in a pressurizable reaction container or vessel, such ones made by Parr® Instrument Company (Molin, Illinois, USA) and Buchiglas USA Corp. (Farmingdale, NY, USA), at pressures ranging from about 15 psi to about 175 psi, alternatively from about 15 psi to about 165 psi, alternatively from about 15 psi to about 155 psi, alternatively from about 15 psi to about 145 psi, and alternatively from about 15 psi to about 135 psi. Generally, the polymerization reaction pressure is achieved via injection of the gaseous monomer(s) to be polymerized (e.g., ethylene, gaseous olefins). In some instances, the pressure is achieved via injection of a combination of the gaseous monomer(s) to be polymerized and an inert gas such as nitrogen or argon. In instances where the olefin to be polymerized is in liquid form or dissolved in a solvent, the pressure is achieved via injection of an inert gas such as nitrogen or argon.

Polymerization reactions can be accomplished using from about 1 mmol to about 20 mmol, alternatively from about 2.5 mmol to about 17.5 mmol, from about 5 mmol to about 15 mmol, from about 7.5 mmol to about 12.5 mmol, and alternatively about 10 mmol of a catalyst according to Formula 1. In some instances, the catalyst can be used in conjunction with a salt that promotes the catalyst's function while having an anionic component that will not coordinate to the metal center of the catalyst or otherwise interfere with the catalytic cycle. Suitable examples of such promoting salts include, but are not limited to, sodium tetrakis[3,5-bis(trifluoromethyl)phenyl]borate (NBArF) and lithium tetrakis(pentafluorophenyl)borate.

Polymerization reactions can employ any suitable solvent or mixture of solvents. One of ordinary skill in the art can determine suitable solvents or solvent systems to be used in the polymerization of ethylene and/or olefins based upon experience and common knowledge. Polymerization reactions can conducted while stirring and for any suitable amount of time.

### Optimal Stir Rates and Reaction Times can be Determined by Routine Experimentation

A general synthetic protocol for a PE or PO homopolymer or a P(E-co-O) copolymer can be as follows. First, a pressurizable reactor with a stirring bar is heated to a temperature and for time sufficient to vaporize and remove water molecules contained with the reactor, and then cooled to room temperature. The reactor can then be placed in an inert environment, such as a glove box, and charged with the promoting salt (for example, NaBArF). Suitable solvent(s) (for example, chlorobenzene) can then be introduced into the reactor, and reactor can then be pressurized to the desired pressure of ethylene or olefin (or ethylene and olefin for the formation of a P(E-co-O) copolymer) and maintained at said pressure for a period of time (for example, about 1 to about 30 minutes, alternatively from about 5 to about 20 minutes, alternatively from about 5 to about 15 minutes, and alternatively about 10 minutes). Then, the reactor can be vented and a catalyst-containing solution can be injected into the reactor under ethylene and/or olefin flow. With an oil, water or sand bath, or an external heating element, the temperature of the reactor can be maintained during the course of the synthesis. The reactor can be pressurized to the desired ethylene and/or olefin pressure and stirred for the given reaction time, and then carefully vented. The polymerization can be stopped by quenching with, for example, triethylsilane and then pouring into, for example, acetone to obtain a solid polymer. The solid polymer can then be filtered and dried under vacuum to reach a constant weight.

In instances, where a P(E-co-Acrylate), P(E-co-Methacrylate), P(O-co-Acrylate), or P(O-co-Methacrylate) copolymer is to be synthesized, the above procedure can be followed with the exception that the one or more acrylates or one or more methacrylates are added to the reactor at the same time, or procedurally around the same time, as the catalyst-containing solution.

In accordance with various aspects of the disclosure, catalysts according to Formula 1 can be used in the formation of PE or PO homopolymers or P(E-co-O), P(E-co-Acrylate), P(E-co-Methacrylate), P(O-co-Acrylate), and P(O-co-Methacrylate) copolymers as discussed above to form a first block of a diblock copolymer. Once the first block has been formed, the formation of a second block of the diblock copolymer from a second monomer source is performed. Synthesis of the second block can be accomplished either in a “one-pot” reaction system where the first block is formed in a reaction vessel, as described above, followed by injection of the second block monomers into the reaction vessel and polymerization of the second block monomers using the catalyst already present in the reaction vessel from the first block synthesis. In some instances, the first block can be synthesized, isolated and purified prior to synthesis of the second block to form the diblock copolymer by reacting the first block, second block monomers a catalyst. In preferred embodiments, formation of a diblock copolymer is accomplished in a one-pot reaction system. In either reaction strategy, catalysts according to Formula 1 can be used to form both the first and second block of the diblock copolymer. In instances where the second block is to be a polyacrylate or a polymethacrylate, polymerization of the second block can be accomplished with the aid of light irradiation, such as a RGB blue led light (λₘₐₓ=450, 40 W). As such, when synthesis or the second block is to be accomplished with the aid of light irradiation, the pressurizable reactor will be a glass reactor or other type of reactor having walls that allow for the transmission of light therethrough.

Various diblock copolymers can be synthesized using catalysts according to Formula 1 and the general synthetic procedures described herein. In accordance with various aspects of the disclosure, general diblock copolymer groups that can be synthesized include, but are not limited to PE-b-P(Acrylate), PO-b-P(Acrylate), P(E-co-O)-b-P(Acrylate), P(E-co-Acrylate)-b-P(Acrylate), P(E-co-Methacrylate)-b-P(Acrylate), P(O-co-Acrylate)-b-P(Acrylate), P(O-co-Methacrylate)-b-P(Acrylate), PE-b-P(Methacrylate), PO-b-P(Methacrylate), P(E-co-O)-b-P(Methacrylate), P(E-co-Acrylate)-b-P(Methacrylate), P(E-co-Methacrylate)-b-P(Methacrylate), P(O-co-Acrylate)-b-P(Methacrylate), and P(O-co-Methacrylate)-b-P(Methacrylate).

Suitable acrylates for the synthesis of any of the above copolymers and diblock copolymers include, but are not limited to, methyl acrylate, ethyl acrylate, n-butyl acrylate, isobutyl acrylate, tert-butyl acrylate, benzyl acrylate, propgaryl acrylate, pentafluorophenyl acrylate, pentabromobenzyl acrylate, pentabromophenyl acrylate, 2-ethylhexyl acrylate, 2-(methoxyethyl) acrylate, isobornyl acrylate, ethylene glycol phenyl ether acrylate, 2-(dimethylamino)ethyl acrylate, 2-(diethylamino)ethyl acrylate, 3-(dimethylamino)propyl acrylate, 4-hydroxybutyl acrylate, 2-hydroxypropyl acrylate, di(ethylene glycol) ethyl ether acrylate, hydroxypropyl acrylate, ethylene glycol dicyclopentenyl ether acrylate, 2-chloroethyl acrylate, 2-tetrahydropyranyl acrylate, 2-naphthyl acrylate, 9-anthracenylmethyl acrylate, 2,2,3,3,4,4,5,5,6,6,7,7-dodecafluoroheptyl acrylate, 3,5,5-trimethylhexyl acrylate, 2,2,3,3,4,4,4-heptafluorobutyl acrylate, 2,2,3,4,4,4-hexafluorobutyl acrylate, 2,2,2-trifluoroethyl acrylate, 2,2,3,3,3-pentafluoropropyl acrylate, 2-hydroxy-3-phenoxypropyl acrylate, allyl acrylate, and 2,3-dibromopropyl acrylate.

Suitable methacrylates for the synthesis of any of the above copolymers and diblock copolymers include, but are not limited to, methyl methacrylate, ethyl, methacrylate, propyl methacrylate, butyl methacrylate, tert-butyl methacrylate, sec-butyl methacrylate, isobutyl methacrylate, pentafluorophenyl methacrylate, tetrahydrofurfuryl methacrylate, furfuryl methacrylate, hexyl methacrylate, cyclohexyl methacrylate, propgaryl methacrylate, isobornyl methacrylate, phenyl methacrylate, benzyl methacrylate 2-hydroxyethyl methacrylate, 2-(dimethylamino)ethyl methacrylate, 2-(diethylamino)ethyl methacrylate, ethylene glycol methyl ether methacrylate, ethylene glycol phenyl ether methacrylate, diethylene glycol methyl ether methacrylate, diethylene glycol butyl ether methacrylate, 2-ethoxyethyl methacrylate, 1-pyrenemethyl methacrylate, pentabromophenyl methacrylate, pentabromobenzyl methacrylate, hydroxypropyl methacrylate, hydroxybutyl methacrylate, solketal methacrylate, 3,3′-diethoxypropyl methacrylate, 2,2,2-trifluoroethyl methacrylate, 2,2,3,3-tetrafluoropropyl methacrylate, 2,2,3,3,3-pentafluoropropyl methacrylate, 2,2,3,3,4,4,4-heptafluorobutyl methacrylate, 2,2,3,4,4,4-hexafluorobutyl methacrylate, 9-fluorenyl methacrylate, ethylene glycol dicyclopentenyl ether methacrylate, 2-naphthyl methacrylate, 9-anthracenylmethyl methacrylate, (2-Boc-amino)ethyl methacrylate, 2-(diisopropylamino)ethyl methacrylate, 2-ethylhexyl methacrylate, 2-N-morpholinoethyl methacrylate, 2-(methylthio)ethyl methacrylate, 2-(tert-butylamino)ethyl methacrylate, and 3-chloro-2-hydroxypropyl methacrylate.

### EXAMPLES

Materials. All manipulations of air- and water-sensitive compounds were carried out under an inert atmosphere using glovebox, Schlenk, high vacuum techniques unless otherwise noted. Ethylene (Polymer Grade) was purchased from Matheson and used as received. Chloromethyl(1,5-cyclooctadiene)palladium (99%) was purchased from Strem Chemicals and used as received. Sodium tetrakis[3,5-bis(trifluoromethyl)phenyl]borate (NaBArF, 97%) was purchased from Matrix Scientific and used as received. Methylene chloride, pentane, toluene and tetrahydrofuran were purified via an Inert PureSolv MD5 Purification System. Chlorobenzene (anhydrous, ≥99.8%) was purchased from Sigma-Aldrich and degassed by three freeze-pump-thaw cycles under nitrogen gas immediately before use. n-Butyllithium solution (1.6 M in hexanes), p-toluidine (99%), 2,3-butanedione (97%), 4-bromotoluene (98%), chloroform (anhydrous, contains amylenes as stabilizer, ≥99%), triethylsilane (99%) and ethyl formate (97%) were purchased from Sigma-Aldrich. 5-bromo-m-xylene (>98%), p-toluenesulfonic acid monohydrate (>98%) and zinc chloride (>98%) were purchased from TCI. Methyl acrylate (MA, 99%), ethyl acrylate (EA, 99%), n-butyl acrylate (nBA, >99%), tert-butyl acrylate (tBA, 98%), benzyl acrylate (BzA, 99.8%) and methyl methacrylate (MMA, 99%) were purchased from Sigma-Aldrich, were distilled over CaH2 and degassed by three freeze-pump-thaw cycles under nitrogen gas immediately before use. N-Acryloxysuccinimide, (NAS, 99%) was purchased from ACROS Organics and used as received. 1-Pyrenemethylamine hydrochloride (95%) was purchased from Sigma-Aldrich and used as received.

Nuclear Magnetic Resonance (NMR). ¹H and ¹³C NMR were acquired on a JEOL JNM-ECA 400 (400 MHz), JNM-ECZ400S (400 MHz), or ECA-600 (600 MHz). NMR spectrometer equipped with 5 mm broad-band probes. Chemical shifts are measured relative to residual solvent peaks as an internal standard set to δ 7.26 and δ 77.16 (chloroform-di (CDCl₃)) and δ 6.00 and δ 73.78 (1,1,2,2-tetrachloroethane-d₂ (C₂D₂Cl₄)) for ¹H and ¹³C, respectively. 13C NMR spectra of polymers were recorded on the ECA-600 (600 MHz) at 125° C., in C₂D₂Cl₄ with Cr(acac)₃ as a relaxation agent (0.05 M).

Diffusion Ordered NMR Spectroscopy (DOSY) of PE-b-PMA. Sample was prepared by dissolving the PE-b-PMA polymer in 0.5 mL of C₂D₂Cl₄ and was recorded on the ECA-600 (600 MHz) NMR spectrometer at 40° C. The parameters of the experiment for the diffusion time was set to 0.55 s, delta=8.5 ms, relaxation delay=6 s. An exponential array function between 10 mT/m and 275 mT/m for points=32 with 64 scans was applied.

Gel Permeation Chromatography (GPC). Size exclusion chromatography (SEC) was performed using a Tosoh EcoSEC HLC-8321 GPC/HT System equipped with an autosampler, three TSKgel GMHhr-H(S) HT2 columns, built-in dual flow refractive index (RI) detector, viscometer and Wyatt technology DAWN (18 angles) Multi-Angle Light Scattering (MALS) detector. The dn/dc of block copolymers was determined with the ASTRA software/on-line method by Wyatt. The light scattering function used a Zimm model. The absolute molar mass of polymers was determined by triple detection (MALS). SEC analyses were carried out in HPLC grade 1,2,4-trichlorobenzene with a flow rate of 1.0 mL/min at 150° C. calibrated with a polystyrene standard. Samples were dissolved in 1,2,4-tricholorobenzene at 150° C. prior to the measurement.

Mass Spectrometry. Mass spectra of samples were obtained from a Thermo Scientific high-resolution Orbitrap MS instrument equipped with a TriVersa NanoMate nano-electrospray (nESI) source.

Elemental Analysis. Elemental analysis of samples was performed by Atlantic Microlab, Inc.

Differential Scanning Calorimetry (DSC). DSC was conducted on a Mettler-Toledo DSC STAR System. The samples were heated from 25° C. to 200° C., cooled to −100° C., and then heated to 200° C. at a rate of 10° C./minute. DSC data was obtained from the second heating cycles.

Small Angle X-ray Scattering (SAXS). SAXS was performed with a Xenocs Ganesha small angle scattering instrument fitted with a movable Dectris 300k detector was used to record extremely small angle scattering data. The instrument is fitted with a microfocus Cu k-alpha source operated at 50 kV and 0.6 mA. Data were corrected to give the absolute intensities using sample thickness and by measuring Jo directly on the Dectris detector. With a manufacturer supplied utility, SAXSGUI was used to make the corrections and reduce the 2D detector data into intensity vs. scattering angle data. The two-dimensional scattering patterns were azimuthally integrated to a one-dimensional profile of intensity vs scattering vector, q=4π sin(θ/2)/λ (θ is the scattering angle; λ is the wavelength).

Tensile Testing. Tensile testing was carried out on an Instron 5966 universal testing system containing 2 kN load cell. The polymer samples were prepared in dog bone-shaped testing bars (ASTM D638, bar type 5, thickness 1.5 mm). Pneumatic grips (maximum force 2 kN) were used to affix the sample in the testing frame, at a compressed air pressure of 40 psi. The force and change in length were measured as the sample was elongated at a rate of 1 mm/min. The engineered stress was calculated using the measured force and a cross-sectional area of the sample. The engineered strain was measured directly using an Instron extensometer (gauge length 0.3-inch, travel ±0.15 inch). Elastic recovery was tested by applying tensile strain until 300% and then the sample was unloaded fully, followed by a reloading to over 300%.

X-ray Crystallography. X-Ray crystallographic measurements were made with a Bruker diffractometer equipped with a 4K CCD APEX II detector using MoK a radiation at 123 K. The reflections were collected using a narrow-frame algorithm with scan widths of 0.5% in omega and an exposure time of 30 s/frame at 6 cm detector distance. The data were integrated using the Bruker Apex-II program, with the intensities corrected for Lorentz factor, polarization, air absorption, and absorption due to variation in the path length through the detector faceplate. The data were scaled, and an absorption correction was applied using SADABS. Redundant reflections were averaged. The structure was solved by using SHELXT and refined with the program SHELXL 2018. All non-hydrogen atoms were refined anisotropically. The hydrogen atoms were refined isotropically with riding displacement parameters. Highly disordered solvent molecules could not be determined reliably and their contributions to the electron density were treated using the PLATON/SQUEEZE program. The chemical formula and calculated density correspond to the atoms found in the refinement.

Calculation of Branching and Monomer Incorporation in Synthesized Polymers. The branching of polymer and monomer incorporation were calculated according to proton NMR using the following equations.

Equation 1—Branching (per 1000 C)=2(CH₃)/[(2(CH₃)+3(CH₂+CH)]*1000, where CH₃=Integral of CH₃ (0.75-0.95 ppm); CH₂+CH=Integral of CH₂ & CH (1.10-1.50 ppm).

Equation 2—methyl acrylate (MA) incorporation (mol %)=4(OMe)/[4(OMe)+2(CH₃)+3(CH₂+CH)]*100%, where OMe=Integral of OMe group from PMA (3.67-3.82 ppm); CH₃=Integral of CH₃ from PE (0.75-0.95 ppm); CH₂+CH=Integral of CH₂ & CH from PE (1.10-1.45 ppm).

Equation 3—ethyl acrylate (EA) incorporation (mol %)=12(OCH₂)/[3(OCH₂)+6(CH₂+CH+CH₃^{OEt})+4(CH₃)]*100%, where Integral of OCH₂ group from PEA (4.12-4.25 ppm); CH₃=Integral of CH₃ from PE (0.85-0.98 ppm); CH₂+CH+CH₃^{OEt}=Integral of CH₂ & CH from PE and CH₃ from PEA (1.10-1.50 ppm).

Equation 4—n-butyl acrylate (nBA) incorporation (mol %)=6(OCH₂ⁿPr)/[3(CH₂+CH)+2(CH₃)]*100%, where OCH₂ⁿPr=Integral of OCH₂ on OBu group from PnBA (4.05-4.25 ppm); CH₃=Integral of CH₃ from PE & PnBA (0.85-1.08 ppm); CH₂+CH=Integral of CH₂ & CH from PE & PnBA (1.15-1.55 ppm).

Equation 5—t-butyl acrylate (tBA) incorporation (mol %)=12(CH₂CHCOO^{t}Bu)/[3(CH₂+CH+CH₃^{tBu})+2(CH₃)−5(CH₂CHCOO^{t}Bu)]*100%, where CH₂CHCOO^{t}Bu=Integral of CH₂CHCOOtBu from PtBA (2.28-2.42 ppm); CH₃=Integral of CH₃ from PE (0.85-0.98 ppm); CH₂+CH+CH₃^{tBu}=Integral of CH₂ & CH from PE and CH₃ from PtBA (1.11-1.59 ppm).

Equation 6—benzyl acrylate (BzA) incorporation (mol %)=6(OCH₂Ph)/[6(OCH₂Ph)+2(CH₃)+3(CH₂+CH)]*100%, where OCH₂Ph=Integral of OCH₂Ph group from PBzA (5.10-4.96 ppm); CH₃=Integral of CH₃ from PE (0.75-0.95 ppm); CH₂+CH=Integral of CH₂ & CH from PE (1.10-1.48 ppm).

Equation 7—methyl methacrylate (MMA) incorporation (mol %)=4(OMe)/[4(OMe)+2(CH₃)+3(CH₂+CH)]*100%, Where OMe=Integral of OMe group from PMMA (3.61-3.74 ppm); CH₃=Integral of CH₃ from PE (0.80-0.95 ppm); CH₂+CH=Integral of CH₂& CH from PE (1.15-1.47 ppm).

General Procedure for Ethylene Homopolymerization Reactions. A Büchi Glas Uster Parr reactor with a stirring bar was heated to 110° C. for 1 hour and then cooled to room temperature. The parr reactor was placed in a glove box and charged with NaBArF. The Parr reactor was removed from the glove box and placed into a glove bag. Chlorobenzene was introduced to the Parr reactor and reactor was pressurized to the desired pressure of ethylene and maintained for 10 minutes. Then the reactor was vented and a 5.0 mL solution of palladium catalyst was injected under ethylene flow. With an oil bath the temperature of the glass reactor was kept constant. The autoclave was pressurized to the desired ethylene pressure and stirred for the given reaction time, and then carefully vented. The reaction solution was quenched by adding 0.1 mL of triethylsilane and then poured into 500 mL of acetone. The solid polymer was filtered and dried under vacuum to reach a constant weight.

General Procedure for Ethylene/Methyl Acrylate Copolymerization. A Büchi Glas Uster Parr reactor with a stirring bar was heated to 110° C. for 1 hour and then cooled to room temperature. The Parr reactor was placed in a glove box and charged with NaBArF. The parr reactor was removed from the glove box and placed into a glove bag. Chlorobenzene was introduced to the Parr reactor and reactor was pressurized to the desired pressure of ethylene and maintained for 10 minutes. After venting, the desired amount of acrylate and a 1.0 mL solution of palladium catalyst was then introduced and the reactor was pressurized to desired ethylene pressure. The reactor was carefully vented after stirring for the given time. The volatiles were removed by vacuum at 70° C. to obtain the copolymer. The polymer was dissolved in hot toluene and filtered through celite. After removing the solvent, the copolymer was washed with methanol. The polymer was filtered and dried under vacuum overnight. In alternative procedures, the PE-co-MA can be purified by introducing excess of acetone into the solution followed by filtering and washing with acetone and drying under vacuum overnight.

General Procedure for Ethylene/Acrylates Block Copolymerization. A Büchi Glas Uster Parr reactor with a stirring bar was heated to 110° C. for 1 hour and then cooled to room temperature. The Parr reactor was placed in a glove box and charged with NaBArF. The parr reactor was removed from the glove box and placed into a glove bag. Chlorobenzene was introduced to the Parr reactor and reactor was pressurized to the desired pressure of ethylene and maintained for 10 minutes. Then the reactor was vented and a 5.0 mL solution of palladium catalyst was injected under ethylene flow. The autoclave was pressurized to desired ethylene pressure and stirred for the given reaction time, and then carefully vented. The acrylate monomer (neat) was injected to the reactor and then sealed. The reaction was irradiated with Sunnet RGB blue led light (λₘₐₓ=450, 40 W) for 6 hours. After irradiation, the series of block copolymers were isolated by precipitation in methanol followed by Soxhlet extraction with cyclohexene and butanone. The recovered yields of PE-b-PnBuA and PE-b-PBzA were 70-75%. For all other block copolymers such as PE-b-PMA, PE-b-PMMA, PE-b-PtBuA the recovered yields were 80-90%. In alternative procedures, PE-b-PtBuA and PE-b-PMMA can be purified by introducing excess of acetone into the solution followed by filtering and washing with acetone and drying under vacuum overnight.

General Procedure for Functionalized Ethylene/Acrylates Block Copolymerization. The synthesis of PE-b-P(MA-co-NAS) was conducted in the same fashion but adding a 5.0 mL chlorobenzene solution containing MA and NAS with a 2:1 feed ratio (0.5 g of both monomers). The block copolymer was purified by precipitation in methanol followed by washing with methanol and acetone and dried under vacuum. Post-modification with dye was conducted by first dissolving 30 mg of PE-b-P(MA-co-NAS) in 2 mL 1,1,2,2-tetrachloroethane at 125° C. After the polymer was dissolved, a 0.2 mL tetrachloroethane solution of 1-pyrenemethylamine (39 mg, 10 eq. calculated for the NAS groups) was added and stirred overnight. The modified block copolymer was purified by precipitation in methanol and followed by washing with methanol and acetone. (1-Pyrenemethylamine was prepared from 1-pyrenemethylamine hydrochloride by extraction with sodium hydroxide solution/methylene chloride, and drying under vacuum).

### Synthesis of bis(3,5-dimethylphenyl)methanol (1a)

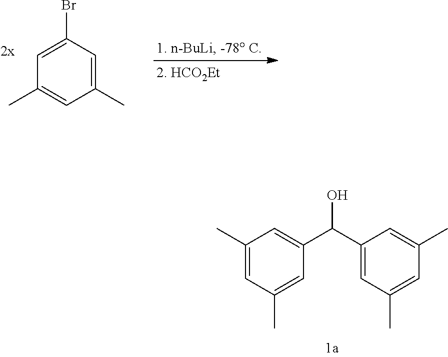

To a dried 250 mL round-bottomed flask filled with nitrogen was added 5-bromo-m-xylene (7.4 g, 40 mmol) and anhydrous THE (100 mL). The solution was cooled to −78° C. and n-BuLi was added (1.6 M in hexanes, 27.5 mL, 44 mmol) dropwise over 10 mins. After stirring for 1 hour at −78° C., ethyl formate (1.48 g, 20 mmol) was added dropwise to the mixture. The mixture was slowly warmed to room temperature and stirred overnight. The reaction was quenched by addition of saturated ammonium chloride solution and extracted with methylene chloride. The organic phase was dried over sodium sulfate, filtered, and concentrated under reduced pressure to provide crude product. The alcohol was purified by recrystallization from methylene chloride and hexanes, and then dried under vacuum to give a white solid. Yield: 4.5 g, 94%. Synthesis of 1a was confirmed by NMR.

### Synthesis of 2,6-bis(bis(3,5-dimethylphenyl)methyl)-4-methylaniline (1b)

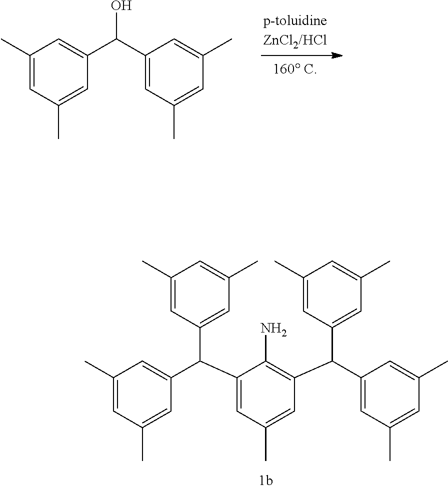

1a (3.6 g, 15 mmol) and p-toluidine (802 mg, 7.5 mmol) were added to a 100 mL round-bottomed flask and heated to 120° C. until liquefied. Zinc chloride (510 mg, 3.75 mmol) was dissolved in hydrogen chloride (36% in water, 0.66 mL, 7.5 mmol) and added to the mixture (This addition is accompanied with vigorous gas evolution). The flask was sealed immediately after addition. The reaction was heated to 160° C. and stirred. After 2 hours, the mixture was cooled to room temperature and dissolved in 40 mL of methylene chloride. The organic phase was washed with brine and dried over sodium sulfate. The solution was concentrated and recrystallized from methanol. The resulting white solid was dried under vacuum. Yield: 3.6 g, 87%. Synthesis of 1b was confirmed by NMR.

### Synthesis of N—N′-bis(2,6-bis(bis(3,5-dimethylphenyl)methyl)-4-methylphenyl)butane-2,3-diimine (1c)

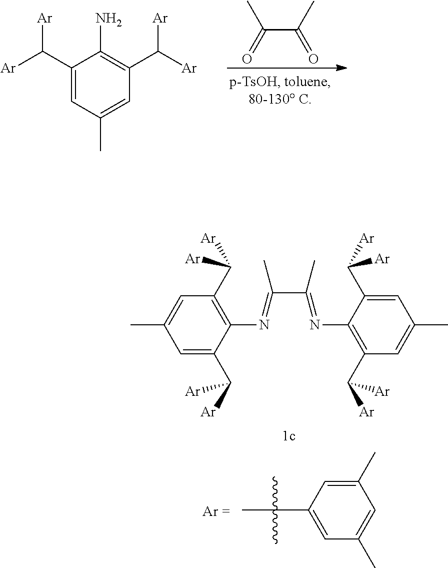

To a dried 100 mL round-bottomed flask was sequentially added 1b (4.75 g, 8.6 mmol), p-toluenesulfonic acid monohydrate (38 mg, 0.2 mmol), toluene (50 mL) and 2,3-butadione (370 mg, 4.3 mmol). After addition, a drying tube filled with calcium chloride was fitted on the top of reflux condenser and stirred at 80° C. After 24 hours, the reaction was heated to 130° C. and stirred for 48 hours. The mixture was concentrated under reduced pressure to give crude product, which was recrystallized from methylene chloride and methanol. The pale-yellow solid was filtered and dried under vacuum. Yield: 3.7 g, 75%. ¹H NMR (400 MHz, CDCl₃): δ 6.76 (s, 4H, aryl-H), 6.74 (s, 4H, aryl-H), 6.63 (s, 12H, aryl-H), 6.53 (s, 8H, aryl-H), 4.98 (s, 4H, CHAr2), 2.17 (s, 6H, aryl-CH₃), 2.14 (s, 48H, aryl-CH₃), 1.19 (s, 6H, CH₃). ¹³C NMR (150 MHz, CDCl₃): δ 169.50 (N=CMe), 145.69 (Me-Cp-Ar), 143.73, 143.45, 137.53, 137.13, 131.44, 131.37, 128.96, 127.91, 127.88, 127.62, 127.57, 51.91 (CHPh₂), 21.56, 21.46, 21.44, 17.07 (N=CMe). HRMS (ESI) m/z: [M+H]⁺ Calcd for C₈₆H₉₃N₂: 1153.7333. Found: 1153.7340.

### Synthesis of [N—N′-bis(2,6-bis(bis(3,5-dimethylphenyl)methyl)-4-methylphenyl)butane-2,3-diimine]·PdMeCl (1)

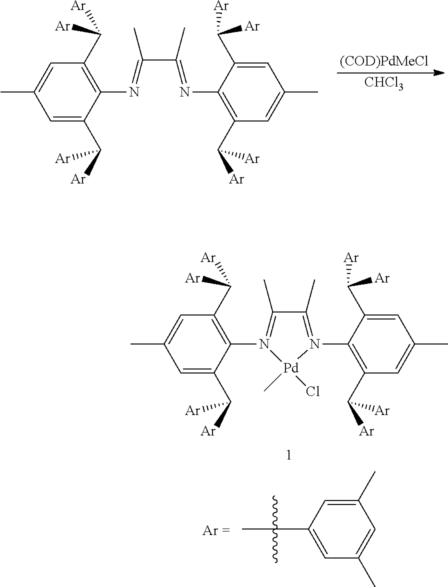

A 100 mL round-bottomed flask was charged with 1c (577 mg, 0.5 mmol), chloromethyl(1,5-cyclooctadiene)palladium (132.5 mg, 0.5 mmol) and chloroform (30 mL). The reaction was stirred at room temperature for 3 days, and the color of solution turned red. The mixture was filtered through celite and dried under vacuum. The resulting product was purified by recrystallization from chloroform and filtered. The orange solid was washed with cold methylene chloride and pentane and dried under vacuum. Yield: 426 mg, 65%. ¹H NMR (400 MHz, CDCl₃): δ 7.14 (s, 4H, aryl-H), 7.01 (s, 2H, aryl-H), 7.00 (s, 4H, aryl-H), 6.79 (s, 4H, aryl-H), 6.73 (s, 4H, aryl-H), 6.69 (s, 2H, aryl-H), 6.63 (s, 4H, aryl-H), 6.54 (s, 4H, aryl-H), 5.74 (s, 2H, CHAr₂), 5.40 (s, 2H, CHAr₂), 2.28 (s, 3H, aryl-CH₃), 2.21 (s, 15H, aryl-CH₃), 2.17 (s, 12H, aryl-CH₃), 2.03 (s, 12H, aryl-CH₃), 1.94 (s, 12H, aryl-CH₃), 0.65 (s, 3H, Pd—CH₃), 0.50 (s, 3H, CH₃), 0.45 (s, 3H, CH₃). ¹³C NMR (150 MHz, CDCl₃): δ 176.42 (N=CMe), 171.87 (N=CMe), 143.69, 143.51, 143.45, 142.70, 141.65, 141.14, 137.82, 137.79, 137.77, 137.32, 135.75, 135.12, 134.88, 134.31, 129.84, 129.73, 128.44, 128.32, 128.22, 128.05, 128.03, 127.99, 127.63, 51.72 (CHPh₂), 51.20 (CHPh₂), 21.90 (CH₃), 21.75 (CH₃), 21.56 (CH₃), 21.46 (CH₃), 21.33 (CH₃), 21.17 (CH₃), 20.16 (N=CMe), 19.18 (N=CMe), 5.87 (Pd-Me). HRMS (ESI) m/z: [M-Cl]⁺ Calcd for C₈₇H₉₅N₂Pd: 1273.6525. Found: 1273.6543. Anal. Calcd for C₈₇H₉₅ClN₂Pd: C, 79.73; H, 7.31; N, 2.14. Found: C, 79.58; H, 7.43; N, 2.09.

### Synthesis of di-p-tolylmethanol (2a)

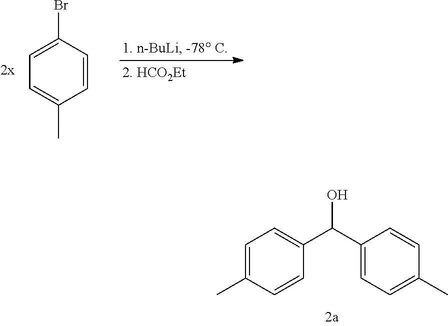

A flame dried 250 mL round-bottomed flask was charged with 4-bromotoluene (13.7 g, 80 mmol) and filled with nitrogen. After injecting dried THF (150 mL), the reaction was cooled to −78° C. n-BuLi (1.6 M in hexanes, 52.5 mL, 84 mmol) was introduced to the solution dropwise over 10 mins. After 1 hour stirring at −78° C., ethyl formate (2.96 g, 40 mmol) was injected dropwise to the solution. The solution was warmed to room temperature slowly and stirred overnight. The reaction was quenched by adding saturated ammonium chloride solution and washed with methylene chloride. The organic phase was dried over sodium sulfate, filtered, and dried under vacuum. The desired product was purified by recrystallization from hexanes and methylene chloride, and then dried under vacuum to give white solid. Yield: 7.5 g, 88%. Synthesis of 2a was confirmed by NMR.

### Synthesis of 2,6-bis(di-p-tolylmethyl)-4-methylaniline (2b)

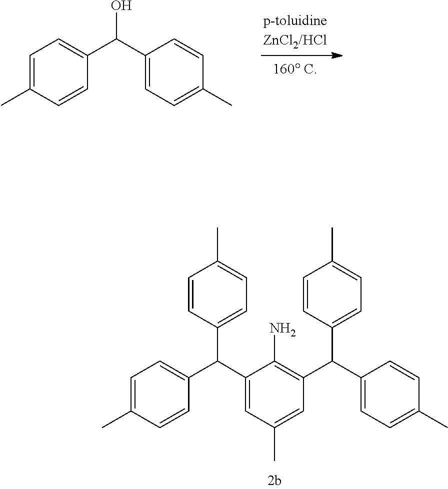

A 200 mL round-bottomed flask was charged with 2a (5.94 g, 28 mmol) and p-toluidine (1499 mg, 14 mmol) and heated to 80° C. Zinc chloride (954 mg, 7 mmol) was dissolved in hydrogen chloride (36% in water, 1.23 mL, 14 mmol) and introduced to the flask (This adding is accompanied with vigorous gas evolution). The flask was sealed immediately after adding ZnCl/HCl. The mixture was heated to 160° C. and stirred. After 1.5 hour, the reaction was cooled to room temperature and dissolved in 50 mL of methylene chloride. The organic phase was washed with brine and dried over potassium carbonate. The solution was concentrated and recrystallized from methanol. The desired white solid was dried under vacuum. Yield: 6.5 g, 94%. Synthesis of 2b was confirmed by NMR.

### Synthesis of N—N′-bis(2,6-bis(di-p-tolylmethyl)-4-methylphenyl)butane-2,3-diimine (2c)

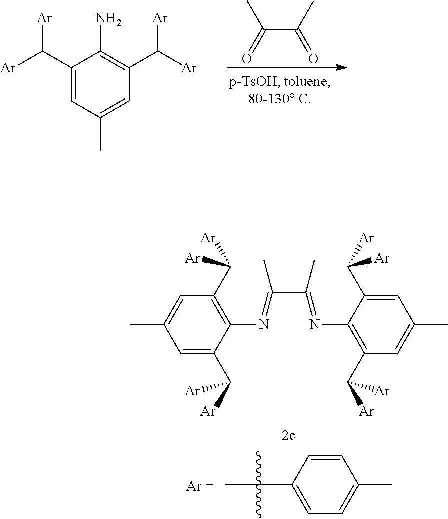

To a dried 200 mL round-bottomed flask was sequentially introduced 2b (4.96 g, 10 mmol), p-toluenesulfonic acid monohydrate (57 mg, 0.3 mmol), toluene (60 mL) and 2,3-butadione (430 mg, 5 mmol). After adding, a drying tube filled with calcium chloride was fitted on the top of condenser and stirred at 80° C. for 1 day. The reaction was heated to 130° C. and stirred overnight. The solution was concentrated and recrystallized from methanol. The resulting yellow solid was filtered and dried under vacuum. Yield: 4.8 g, 92%. ¹H NMR (400 MHz, CDCl₃): δ 6.99-6.83 (m, 32H, aryl-H), 6.67 (s, 4H, aryl-H), 5.06 (s, 4H, CHAr₂), 2.28 (s, 12H, aryl-CH₃), 2.26 (s, 12H, aryl-CH₃), 2.14 (s, 6H, aryl-CH₃), 1.19 (s, 6H, CH₃). ¹³C NMR (150 MHz, CDCl₃): δ 169.77 (N=CMe), 145.91 (Me-Cp-Ar), 141.43, 140.57, 135.71, 135.38, 131.75, 131.31, 129.72, 129.45, 129.13, 128.89, 128.87, 51.06 (CHPh₂), 21.42, 21.13, 16.83 (N=CMe). HRMS (ESI) m/z: [M+H]⁺ Calcd for C₇₈H₇₇N₂: 1041.6081. Found: 1041.6073.

### Synthesis of [N—N′-bis(2,6-bis(di-p-tolylmethyl)-4-methylphenyl)butane-2,3-diimine]·PdMeCl (2)

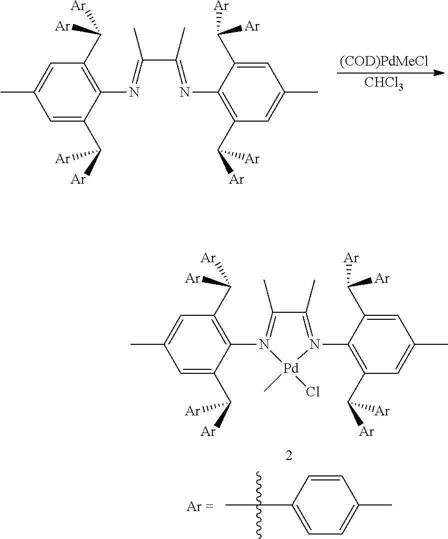

A 100 mL round-bottomed flask was sequentially charged with 2c (521 mg, 0.5 mmol), chloromethyl(1,5-cyclooctadiene)palladium (132.5 mg, 0.5 mmol) and chloroform (50 mL). The reaction was stirred at room temperature for 3 days. The red solution was filtered through celite and dried under vacuum. The residual solid was washed with methylene chloride, and the eluate was collected and dried under vacuum. The desired product was purified by recrystallization from chloroform/pentane and filtered. The orange solid was washed with pentane and dried under vacuum. Yield: 481 mg, 81%. ¹H NMR (400 MHz, CDCl₃): δ 7.34 (d, J=7.6 Hz, 4H, aryl-H), 7.22 (d, J=8.0 Hz, aryl-H), 7.05-6.96 (m, 14H, aryl-H), 6.91-6.75 (m, 14H, aryl-H), 5.88 (s, 2H, CHAr₂), 5.64 (s, 2H, CHAr₂), 2.29 (s, 6H, aryl-CH₃), 2.27 (s, 6H, aryl-CH₃), 2.24 (s, 3H, aryl-CH₃), 2.23 (s, 6H, aryl-CH₃), 2.20 (s, 6H, aryl-CH₃), 2.17 (s, 3H, aryl-CH₃), 0.71 (s, 3H, Pd—CH₃), 0.33 (s, 3H, CH₃), 0.18 (s, 3H, CH₃). ¹³C NMR (150 MHz, CDCl₃): δ 176.41 (N=CMe), 171.87 (N=CMe), 143.69, 143.51, 143.44, 142.70, 141.65, 141.14, 137.82, 137.79, 137.76, 137.32, 135.75, 135.12, 134.87, 134.31, 129.84, 129.73, 128.43, 128.32, 128.22, 128.04, 128.02, 127.99, 127.63, 51.71 (CHPh₂), 51.19 (CHPh₂), 21.90 (CH₃), 21.75 (CH₃), 21.56 (CH₃), 21.46 (CH₃), 21.32 (CH₃), 21.16 (CH₃), 20.16 (N=CMe), 19.17 (N=CMe), 5.86 (Pd-Me). HRMS (ESI) m/z: [M-Cl]⁺ Calcd for C₇₉H₇₉N₂Pd: 1161.5273. Found: 1161.5298. Anal. Calcd for C₇₉H₇₉ClN₂Pd: C, 79.18; H, 6.64; N, 2.34. Found: C, 78.89; H, 6.61; N, 2.43.

Results and Discussion

The preparation of the complexes 1 ([N—N′-bis(2,6-bis(bis(3,5-dimethylphenyl)methyl)-4-methylphenyl)butane-2,3-diimine]-PdMeCl) and 2 ([N—N′-bis(2,6-bis(di-p-tolylmethyl)-4-methylphenyl)butane-2,3-diimine]-PdMeCl) started with synthesis of the diimine ligands by forming two aniline derivatives through substitution reactions yielding compounds 1a and 2a, respectively, followed by the synthesis of aniline derivatives 1b and 2b, respectively, through arylalkylation reactions. In an adapted reaction procedure, the two diimine ligands 1c and 2c were formed through a condensation reaction in high yields (FIG. 2). The following synthesis of the respective Pd(II) complexes was performed in chloroform with (COD)PdMeCl and yielded 65% for complex 1 with m-xylyl groups and 81% for complex 2 with p-tolyl substituents in an updated procedure.

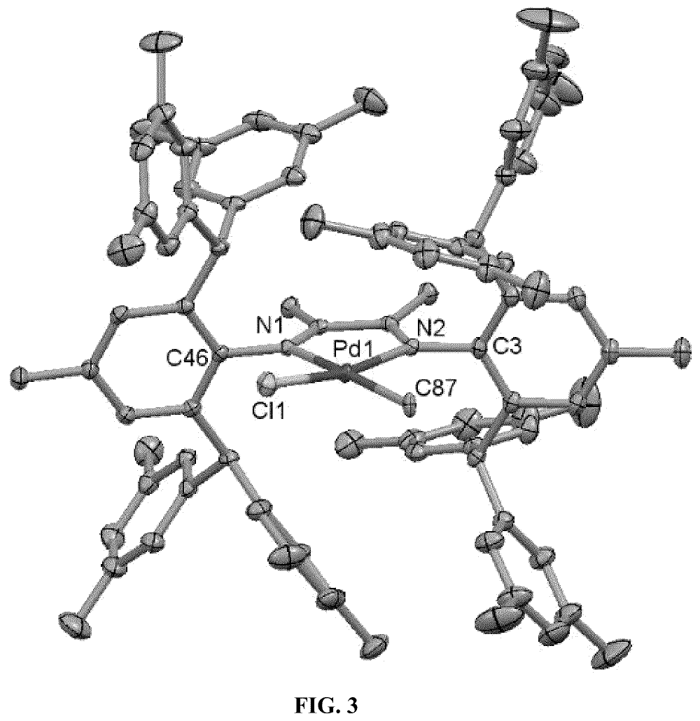

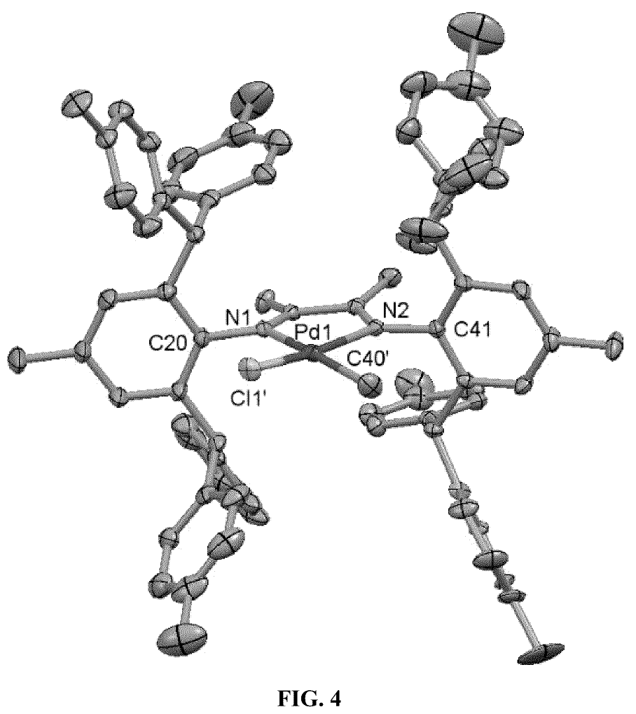

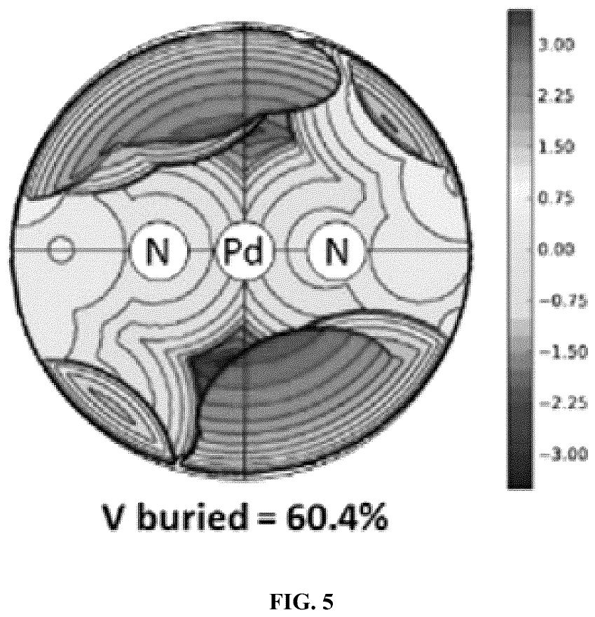

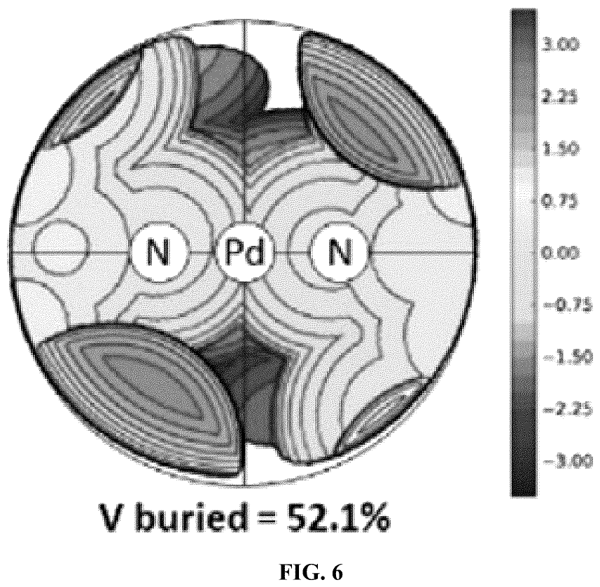

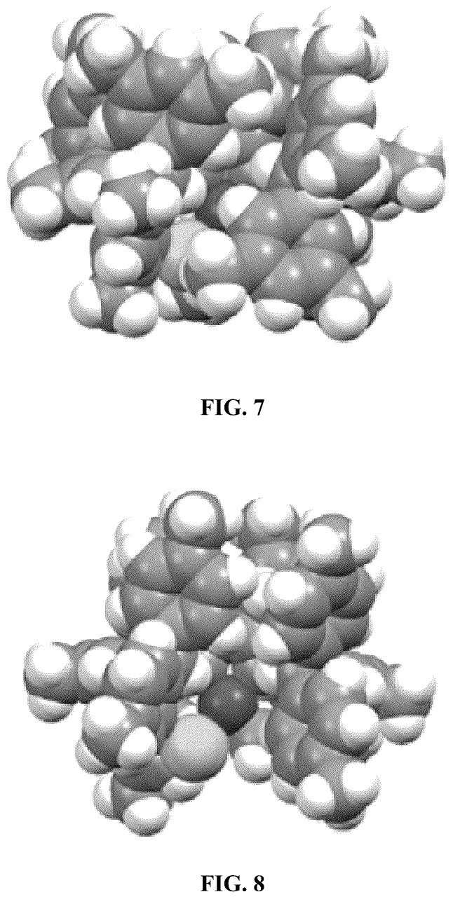

The x-ray crystallographic structures of both complex 1 (FIG. 3) and 2 (FIG. 4) exhibit slightly distorted square planar geometries at the Pd center. The calculation for steric map and buried volume V_{Bur}% of catalysts showed that V_{Bur} of 1 is 60.4% which is greater than the value of 2 (52.1%). FIGS. 5 and 6 are steric maps of complexes 1 and 2, respectively. Specifically, in complex 1, the two m-xylyl rings cap the Pd like a distorted sandwich and the methyl substituents at the meta position of the phenyl rings are providing a rotation barrier which prove to be more shielding than at the para position. The difference of axial shielding between complexes 1 and 2 can be differentiated from the space-filling model. FIGS. 7 and 8 are space-filling models of complexes 1 and 2, respectively. The axial sites of complex 1 were blocked by the ligand, but complex 2 displayed a more open structure. The m-xylyl backbone appears to provide efficient shielding and the Pd is buried by m-xylyl moieties. Crystal data and structure refinement for complexes 1 and 2 are provided in Table 1 below.

TABLE 1

| Complex | 1 | 2 |
|---|---|---|
| Empirical formula | C₈₇H₉₅ClN₂Pd, | C₇₉H₇₉ClN₂Pd |
| | 2(CHCl₃) | |
| Formula weight | 1549.23 | 1198.29 |
| Temperature/K | 123(2) | 123(2) |
| Crystal system | triclinic | orthorhombic |
| Space group | P-1 | Pca2₁ |
| a/Å | 12.6369(3) | 34.677(2) |
| b/Å | 14.8303(3) | 12.8366(8) |
| c/Å | 24.9729(6) | 18.0921(10) |
| α/° | 93.0800(10) | 90 |
| ß/° | 95.4760(10) | 90 |
| γ/° | 108.5460(10) | 90 |
| Volume/Å³ | 4399.28(18) | 8053.5(8) |
| Z | 2 | 4 |
| ρ_{calc}g/cm³ 1.170 | 1.170 | 0.988 |
| 0.988 | | |
| μ/mm⁻¹ | 0.465 | 0.300 |
| F(000) | 1620.0 | 2520.0 |
| Crystal size/mm³ | 0.46 × 0.23 × 0.19 | 0.38 × 0.25 × 0.23 |
| Radiation | MoKα (λ = 0.71073) | MoKα (λ = 0.71073) |
| 2Θ range for data | 2.908 to 56.76 | 3.254 to 56.562 |
| collection/° | | |
| Index ranges | −16 ≤ h ≤ 16, | −31 ≤ h ≤ 46, |
| | −19 ≤ k ≤ 19, | −17 ≤ k ≤ 16, |
| | −33 ≤ 1 ≤ 33 | −20 ≤ 1 ≤ 24 |
| Reflections | 142402 | 40034 |
| collected | | |
| Independent | 21797 [Rᵢₙₜ = 0.0354, | 16680 [Rᵢₙₜ = 0.0373, |
| reflections | R_{sigma} = 0.0255] | R_{sigma} = 0.0503] |
| Data/restraints/ | 21797/784/912 | 16680/1049/837 |
| parameters | | |
| Goodness-of-fit | 1.054 | 1.028 |
| on F² | | |
| Final R indexes | R₁ = 0.0453, | R₁ = 0.0356, |
| [I >= 2σ (I)] | wR₂ = 0.1147 | wR₂ = 0.0828 |
| Final R indexes | =0.0518, | R₁ = 0.0420, |
| [all data] | wR₂ = 0.1185 | wR₂ = 0.0854 |
| Largest diff. peak/ | 1.29/−1.34 | 0.52/−0.75 |
| hole/e Å⁻³ | | |

To evaluate the effects of the geometries in the prepared catalyst complexes, we started with polymerization of ethylene using a Büchi glass Parr reactor and an in-situ activation with 1.2 equivalents of sodium tetrakis(3,5-bis(trifluoromethyl)-phenyl)borate (NaBArF). Catalyst 1 and 2 were both highly active and robust in ethylene polymerizations in temperature ranges from 0° C. to 80° C. (Table 2). With increasing temperatures, the productivity and turnover frequency (TOF) of catalyst 1 and 2 also increased and reached their maximum at 40° C. Catalyst 1 showed the lowest activity at 0° C. (TOF=714 h⁻¹) and highest activity at 40 8 C (TOF=41714 h⁻¹). In the overall temperature range between 0° C. to 80° C., the activity of catalyst 1 significantly varied. The activity of catalyst 2 is almost constant between 20° C. and 60° C., but the molecular weights of polyethylene (PE) decreased when higher temperatures above 40° C. were applied. In comparison, PE molecular weights formed using catalyst 1 also reached the maximum together with TOF at 40° C. The branching density of PE produced by catalysts 1 and 2 is around 20 branches per 1000 C which is relatively low compared to previously reported α-diimine Pd catalysts. Even though xylyl groups in catalyst 1 provide a higher axial blockage compared to catalyst 2, the difference in branching is only minor. The branching of PE generated from catalyst 1 is independent of the applied temperature, but slightly increases with raising temperatures when using 2. Due to the high activity and low branching nature of catalysts 1 and 2, PE from both catalysts appeared as white solid with a 35% crystallinity and a melting temperature of around 110° C.

TABLE 2
Ethylene Polymerization.

| | | | | | Productivity | |
|---|---|---|---|---|---|---|
| Entry | Cat. | Temp (° C.) | Time (min) | Yield (g) | (kg/mol_{Pd} · h) | TOF (h⁻¹) |
| 1 | 1 | 0 | 60 | 0.20 | 20 | 714 |
| 2 | 1 | 20 | 20 | 0.33 | 99 | 3536 |
| 3 | 1 | 40 | 15 | 2.92 | 1168 | 41714 |
| 4 | 1 | 60 | 15 | 1.85 | 740 | 26429 |
| 5 | 1 | 80 | 15 | 1.05 | 420 | 15000 |
| 6 | 2 | 0 | 60 | 0.67 | 67 | 2393 |
| 7 | 2 | 20 | 20 | 1.72 | 516 | 18429 |
| 8 | 2 | 40 | 15 | 1.83 | 732 | 26142 |
| 9 | 2 | 60 | 15 | 1.77 | 708 | 25286 |
| 10 | 2 | 80 | 15 | 0.98 | 392 | 14000 |
| 11^{e} | 1 | 25 | 60 | 2.22 | 222 | 7929 |
| 12 | 1 | 25 | 15 | 1.21 | 484 | 17286 |
| 13 | 2 | 25 | 60 | 1.33 | 133 | 4750 |
| 14^{e} | 2 | 25 | 15 | 1.37 | 548 | 19571 |

Ethylene Polymerization.ª

| Entry | Cat. | Branches/1000 C^{b} | Mₙ (kg/mol)^{c} | M_{w}/Mₙ^{c} | Tₘ (° C.)^{d} | Crystallinity (%)^{d} |
|---|---|---|---|---|---|---|
| 1 | 1 | 21 | 56.7 | 1.19 | 111.7 | 36.4 |
| 2 | 1 | 19 | 89.3 | 1.14 | 111.2 | 34.3 |
| 3 | 1 | 17 | 295.2 | 1.33 | 105.8 | 30.6 |
| 4 | 1 | 17 | 161 | 1.52 | 104.0 | 35.0 |
| 5 | 1 | 18 | 80.5 | 1.62 | 103.0 | 35.0 |
| 6 | 2 | 21 | 98.7 | 1.07 | 112.4 | 36.3 |
| 7 | 2 | 19 | 233.4 | 1.09 | 104.5 | 27.3 |
| 8 | 2 | 20 | 215.2 | 1.27 | 99.2 | 27.5 |
| 9 | 2 | 23 | 68.0 | 1.58 | 90.6 | 34.7 |
| 10 | 2 | 25 | 36.2 | 1.76 | 89.2 | 36.4 |
| 11^{e} | 1 | 20 | 279.3 | 1.06 | 105.1 | 32.6 |
| 12 | 1 | 17 | 1.06 | 1.21 | 108.1 | 29.2 |
| 13 | 2 | 21 | 160.1 | 1.10 | 103.2 | 28.1 |
| 14^{e} | 2 | 18 | 212.5 | 1.11 | 104.3 | 34.8 |

(^{a}Conditions: 10 mmol of Pd catalyst, 1.2 equiv. NaBArF, 135 psi ethylene, 50 mL chlorobenzene.
^{b}Determined by ¹H NMR in D₂-tetrachloroethane at 125° C.
^{c}Determined by SEC in 1,2,4-trichlorobenzene at 150° C. using triple detection.
^{d}Determined by DSC.
^{e}15 psi).
(^{a}Conditions: 10 mmol catalyst, 1.2 equiv. NaBArF, 135 psi ethylene, 50 mL chlorobenzene.
^{b}Determined by ¹H NMR in D₂-tetrachloroethane at 125° C.
^{c}Determined by SEC in 1,2,4-trichlorobenzene at 150° C. using triple detection.
^{d}Determined by DSC.
^{e}15 psi).

To assess the effect of applied pressure for ethylene polymerization a range of 135 psi and 15 psi (˜1 atm) was employed. When using 135 psi, both catalysts 1 and 2 exhibited high activity and yielded high molecular weight PE with narrow dispersities (M_{w}/Mₙ<1.1). Surprisingly, catalyst 1 not only kept a high productivity at 15 psi of ethylene, but still yielded PE with high Mₙ and very narrow dispersity (M_{w}/Mₙ=1.06) even when the polymerization was conducted for an hour at room temperature. High temperature size-exclusion chromatography (HT-SEC) analysis also confirmed that no low Mₙ of PE was generated by catalyst 1 during polymerization. Although catalyst 2 yielded narrow dispersity PE, a small amount of low molecular weight PE was generated resulting from chain transfer and confirmed by HT-SEC analysis. The M_{w}/M values observed for experiments of catalyst 1 at 135 psi and 15 psi were both 1.06, which is fully consistent with a living polymerization behavior. The ¹³C NMR revealed that the branching distribution of PE from catalyst 1 is exclusively consisting of methyl groups and no long-chain branching was detected.

The data indicates that catalysts 1 and 2, due to their phenyl-based steric bulk, are highly active diimine Pd complexes that produce linear PE through a hindered chain-walking ability of the complexes and higher insertion rates. However, living polymerization could be only facilitated by introducing a more effective blocking at the axial sites of the metal center, as observed in catalyst 1. The less bulky, but more rigid. The structure of the framework in complex 1 in contrast to other high steric bulk catalyst may be responsible for the higher linearity and exclusive methyl branching formation in PE and extended livingness of this complex.

In another study, the copolymerization with ethylene and methyl acrylate (MA) was conducted using different pressures of ethylene and concentrations of MA (Table 3).

TABLE 3
Ethylene/Methyl Acrylate Copolymerization.ª

| | | C₂H₄ | [MA] | Yield | TOF | Branches/ |
|---|---|---|---|---|---|---|
| Entry | Cat. | (psi) | (mol/L) | (mg) | (h⁻¹) | 1000 C^{b} |
| 1 | 1 | 15 | 1 | 53 | 95 | 19 |
| 2 | 1 | 50 | 1 | 126 | 9225 | 20 |
| 3 | 1 | 50 | 2 | 44 | 79 | 18 |
| 4 | 1 | 135 | 5 | 46 | 82 | 20 |
| 5 | 2 | 15 | 1 | 71 | 127 | 24 |
| 6 | 2 | 50 | 1 | 218 | 389 | 17 |
| 7 | 2 | 50 | 2 | 128 | 229 | 22 |
| 8 | 2 | 135 | 5 | 47 | 84 | 34 |
| | | Mₙ | | Incorp | Tₘ | |
| Entry | Cat. | (kg/mol)^{c} | M_{w}Mₙ^{c} | (mol %)^{b} | (° C.)^{d} | T_{g} (° C.)^{d} |
| 1 | 1 | 27.8 | 1.85 | 0.56 | 112.0 | −22.8 |
| 2 | 1 | 42.3 | 1.78 | 0.11 | 112.0 | −8.4 |
| 3 | 1 | 25.8 | 1.68 | 0.26 | 112.9 | 12.4 |
| 4 | 1 | 16.6 | 2.09 | 0.17 | 112.1 | −7.7 |
| 5 | 2 | 6.5 | 1.40 | 1.65 | 107.0 | −15.6 |
| 6 | 2 | 15.8 | 2.22 | 0.24 | 111.3 | −1.5 |
| 7 | 2 | 6.2 | 1.96 | 0.21 | 107.2 | 9.1 |
| 8 | 2 | 2.2 | 1.89 | 0.25 | 102.7 | — |

(^{a}Conditions: 10 mmol catalyst, 1.2 equiv. NaBArF, 10 mL chlorobenzene, 2 h, 25° C.
^{b}Determined by ¹H NMR in D₂-tetrachloroethane at 125° C.
^{c}Determined by SEC in 1,2,4-trichlorobenzene at 150° C. using triple detection.
^{d}Determined by DSC.
(^{a}Conditions: 10 mmol catalyst, 1.2 equiv. NaBArF, 10 mL chlorobenzene, 2 h, 258 C.
^{b}Determined by ¹H NMR in D₂-tetrachloroethane at 125° C.
^{c}Determined by SEC in 1,2,4-trichlorobenzene at 150° C. using triple detection.
^{d}Determined by DSC.

The initial experiments were conducted at 15 psi of ethylene and 1.0 M of MA solution at 25° C. for 2.0 h. ¹H NMR analysis of the copolymers showed the indicative signals for a MA incorporation with a singlet at 3.72 ppm which was identified as the MA methyl ester group and multiplets present at 1.50-1.60 and 2.20-2.30 ppm as the peaks for MA methylene groups. The differential scanning calorimetry (DSC) analysis and glass transition temperature (T_{g}) measurements also indicated the formation of poly(ethylene-co-methyl acrylate), as a T_{g} was not detected in ethylene homopolymers. The TOF of catalysts 1 and 2 were decreased to around 100 h⁻¹ which is one order of magnitude lower than without MA present. In addition, the MA incorporation of catalyst 2 reached 1.7 mol %, but a low molecular weight ethylene/MA copolymer (6.5 kg/mol) was generated. Copolymers from catalyst 1 showed only 0.5 mol % of MA incorporation, but the molecular weight was four times higher than with catalyst 2. With ethylene pressure increased to 50 psi, the activity and molecular weight also increased, but the MA incorporation showed an opposite trend. The xylyl groups of catalyst 1 provided steric shielding for hindering the MA coordination and insertion. Overall, the axial blockage of xylyl groups retarded polar functional group binding to metal and chain-transfer, which is key to yield higher molecular weight copolymers. Based on the structural design of catalyst 2, access of MA to the metal center is easier to achieve, which greatly decreases its activity and lower molecular weight copolymers are obtained.

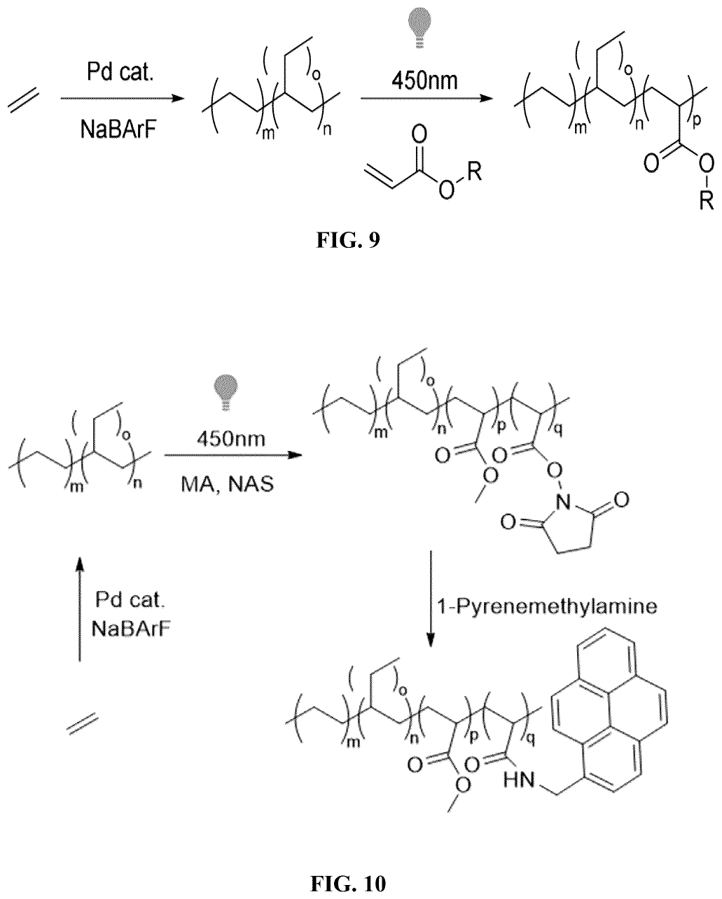

In another experiment, the block copolymerization of ethylene and acrylate monomers was conducted by coordination polymerization of ethylene with catalyst 1, and sequentially adding a selected acrylate monomer, followed by an irradiation with 450 nm blue light to generate the macroradical to initiate the free radical polymerization and forming the second polyacrylate bock segment (FIG. 9). The results of this experiment are shown in Table 4.

TABLE 4
Ethylene/Acrylate Block Copolymerization.ª

| | PE Block | | | | | |
|---|---|---|---|---|---|---|
| | Mₙ | | | Monomer | Yield | Branches/ |
| Entry | (kg/mol)^{d} | M_{w}Mₙ^{d} | Monomer^{b} | (g) | (g) | 1000 C^{c} |
| 1 | 85.0 | 1.11 | MA | 1 | 0.38 | 18 |
| 2 | 80.6 | 1.13 | MA | 5 | 1.24 | 23 |
| 3 | 88.1 | 1.10 | MA | 10 | 2.38 | 19 |
| 4 | 80.4 | 1.10 | EA | 10 | 1.92 | 19 |
| 5 | 80.0 | 1.09 | nBA | 10 | 0.81 | — |
| 6 | 79.3 | 1.11 | tBA | 10 | 1.21 | — |
| 7 | 79.2 | 1.09 | BzA | 10 | 2.84 | 19 |
| 8 | 88.5 | 1.08 | MMA | 10 | 0.46 | — |
| 9^{f} | 16.0 | 1.16 | MA | 2 | 0.11 | — |

| | PE-b-P(acrylate) | | | | |
|---|---|---|---|---|---|
| | Mₙ | | Incorp | Tₘ | |
| Entry | (kg/mol)^{d} | M_{w}Mₙ^{d} | (mol %)^{c} | (° C.)^{e} | T_{g} (° C.)^{e} |
| 1 | 107.1 | 1.11 | 2.0 | 110.3 | — |
| 2 | 231.3 | 1.35 | 39.4 | 110.7 | 15.9 |
| 3 | 552.3 | 1.46 | 62.6 | 109.7 | 14.8 |
| 4 | 377.5 | 1.39 | 68.3 | 109.3 | −16.8 |
| 5 | 753.6 | 1.73 | 76.3 | 109.2 | −49.5 |
| 6 | 1519.2 | 2.03 | 62.7 | 107.7 | 49.9 |
| 7 | 922.9 | 1.11 | 77.7 | 106.8 | 9.4 |
| 8 | 208.6 | 1.51 | 30.4 | 109.8 | — |
| 9^{f} | 101.0 | 1.27 | 74.4 | 109.5 | 12.3 |

(^{a}Conditions: 10 mmol Cat. 1, 1.2 equiv. NaBArF, 50 mL chlorobenzene, 135 psi ethylene, PE block 10 min, polyacrylate block 6 h, 25° C.
^{b}MA (methyl acrylate), EA (ethyl acrylate), nBA (n-butyl acrylate), tBA (t-butyl acrylate), BzA (benzyl acrylate), MMA (methyl methacrylate).
^{c}Determined by ¹H NMR in D₂-tetrachloroethane at 125° C.
^{d}Determined by SEC in 1,2,4-trichlorobenzene at 150° C. using triple detection.
^{e}Determined by DSC.
^{f}20 mmol Cat. 1, PE block 2 min, polyacrylate block 3 h.

From our previous work and discovery of MILRad, we have learned that a living polymerization of the olefin monomer is critical to enable a quantitative generation of polyolefin macroradicals as these originate from the homolytic cleavage of the Pd—C bond through light irradiation. Therefore, we selected complex 1 for the block copolymer synthesis as this catalyst showed living behavior without chain-transfer at room temperature and the ability to produce high molecular weight PE.

We first tested the block copolymerization of ethylene and MA. In a one-pot reaction, we used catalyst 1, NaBArF, and applied a pressure of 135 psi of ethylene to synthesize the PE block. To minimize the chain-transfer product generated during polymerization, a controlled PE block was prepared with M_{w}/Mₙ<1.1 and Mₙ=80-90 kg/mol in the living window of the complex in 10 min reaction time. MA was immediately introduced to the glass parr reactor to synthesize the PMA block sequence under light irradiation at 450 nm. After photoreaction, the composition of the block copolymer showed an overall 2 mol % MA content with a total molecular weight of Mₙ=107 kg/mol. In addition, the morphology of block copolymer was not amorphous but solid, comparable to PE obtained from catalyst 1, but appeared to be less brittle. Increasing the added amount of MA to 5.0 g, the entire block could be extended to 231 kg/mol with a dispersity of M_{w}/Mₙ=1.35. The incorporation of MA increased to 39%, and the texture of the block copolymer appeared as a pliable but strong plastic. By increasing the feeding amount of MA to 10.0 g, the MA incorporation reached up to 63%, and both molecular weight and dispersity also increased (Mn=552 kg/mol, M_{w}/Mₙ=1.46). Interestingly, we discovered that a significant shift to higher molecular weights between the PE block and PE-b-PMA diblocks in HT-SEC traces was not observed.

However, when analyzing the block copolymers by triple detection HT-SEC, the intensity of refractive index (RI) signals decreased with increased MA incorporation. This observation showed that the dn/dc of PE-b-PMA blocks decreased with increasing the molecular weight of the MA sequence and indicated the formation of high molecular weight copolymers. We hypothesize that the hydrodynamic volume of PE-b-PMA in trichlorobenzene is close to original PE block or even smaller.

The ¹H NMR spectrum of PE-b-PMA exhibited not only multiplets of PE alkyl groups at 0.88-0.98 ppm and 1.10-1.48 ppm, but also a singlet of the MA methyl ester group at 3.73 ppm and four prominent multiplets of MA methylene in the PMA block at 1.55-1.65, 1.74-1.80, 2.00-2.08, 2.36-2.48 ppm. DSC measurements of both PE-b-PMAs with 39% and 63% MA content showed the same crystalline melting temperature (Tₘ) and T_{g} values (Tₘ=110° C., T_{g}=15° C.). The appearance and texture of the block containing 63% PMA was similar to the 39% PMA block, but with a higher MA content in the block sequence made the copolymer become more ductile and softer.

The MILRad polymerization technique could also be applied for the synthesis of other ethylene/acrylate block copolymers, including ethyl acrylate (EA), butyl acrylate (nBA), tert-butyl acrylate (tBA), benzyl acrylate (BzA), and methyl methacrylate (MMA). For these blocks, the same conditions to generate the PE block of Mₙ˜80 kg/mol were applied and followed by addition of 10.0 g of the respective acrylates as described above for MA. It was found that the PE-b-PEA showed a high incorporation of EA (68%), a high molecular weight (Mₙ=378 kg/mol) and moderate dispersity (M_{w}/Mₙ=1.39). Since the T_{g} of PEA is much lower (−16.8° C.) than PMA (15.9° C.), PE-b-PEA displayed vastly different properties in contrast to the PE-b-PMA copolymer. The PE-b-PEA appears as a rubbery elastomer, whereas the MA copolymer was a hard plastic-like material but pliable. It is feasible that the T_{g} of the polyacrylate block can significantly modify the overall block copolymer properties. The following diblocks, PE-b-PnBA, PE-b-PtBA and PE-b-PBzA provided further information about the influence of T_{g} towards material properties.

As observed in HT-SEC of PE-b-PnBA, the molecular weight of the block copolymer was significantly increased together with the dispersity which increased to 1.73. The ¹H NMR spectrum of PE-b-PnBA exhibited all the prominent signals of the PE block and PnBA block. DSC analysis of the PnBA block showed a much lower T_{g} of PnBA block (−49° C.) and PE-b-PnBA appeared as a semi-amorphous polymer. As for the PE-b-PtBA, the copolymer was a hard compact plastic and with no elastic behavior. The PE-b-PBzA was a pliable but a strong elastomer, and the elasticity was similar to PE-b-PEA but more tough and stiff. The PE-b-PMMA was a hard plastic and exhibited tough, lightweight and glassy properties originating from PMMA. However, the PMMA block formation is much less efficient and lower yields are obtained when compared to PE-b-PMA. It is believed the methyl group of MMA retards the radical to further react with monomers to propagate, resulting in the lower incorporation % and yield of PE-b-PMMA.

Notably, there was a significant shift in HT-SEC between PE block and PE-b-PnBA which was also observed for PE-b-PtBA, however not in any other blocks generated with PMA, PEA, PBzA, and PMMA blocks. The hydrodynamic volume of the butyl acrylate series is apparently different in the eluting solvent than of any other blocks in the series.

To confirm the formation of block copolymers, Diffusion ordered spectroscopy (DOSY) and Small-angle Xray scattering (SAXS) were applied. The diffusion rate of DOSY depends on the hydrodynamic radius, molecular weight and temperature, therefore this technique is highly valuable to distinguish between block copolymers and mixtures of homopolymers. Since the prepared series of high molecular weight PE/polyacrylate blocks are only soluble in chlorinated solvents at high temperature, the distinct diffusion is challenging to be resolved. Therefore, we synthesized a PE-b-PMA with a shorter PE block content (Mₙ=16 kg/mol) with high solubility at 40° C. The DOSY spectrum showed the corresponding signals of the PE (1.28 ppm) and PMA block segment (3.68, 2.32, 19.6, 1.70 and 1.52 ppm), and aligned around a diffusion coefficient of 1.7×10⁻¹³ m²/s, which supported the formation of PE-b-PMA.

SAXS is also another technique to confirm the presence of block copolymers. Since PE and PMA are completely immiscible with each other, we expected microphase separation to occur in PE-b-PMA. The SAXS of PE-b-PMA showed a broad scattering at 120° C. which indicated a microstructure formation with no long-range order which supported the presence of blocks, in agreement with the MILRad mechanism. Notably, the scattering signal was detected at high temperature but not at 25° C. and the reason for this phenomenon is still unclear. We hypothesize that the crystallization of the semi-crystalline PE block might be prevented in the melt state and a microphase separation can be detected.

Further chemical tuning and post-modification is made possible by the incorporation of active N-acryloyloxysuccinimide (NAS) ester groups. In general, NAS functional groups enable the conjugation of primary amine-carrying entities, such as small molecules and (bio)-macromolecules. A block copolymer composed of PE (˜80 kg/mol) and a random copolymer of MA/NAS was prepared to give a block copolymer (PE-b-P(MA-co-NAS) with 43% active ester functionalization of the acrylate block and an 7% overall active ester content. To demonstrate the ease of the post-functionalization process, a 1-pyrenemethylamine dye was conjugated to activated groups of the block copolymer to produce a green-blue emitting block copolymer with a total molecular weight of Mₙ=170 kg/mol and M_{w}/Mₙ=1.08. A schematic reaction pathway for the polymerization of ethylene to produce polyethylene, followed formation of a (PE-b-P(MA-co-NAS) copolymer, and finally conjugation of the 1-pyrenemethylamine dye to the copolymer is provided in FIG. 10.

Mechanical testing of PE and ethylene/acrylate block copolymers were also tested, the results of which are provided in Table 5.

TABLE 5

| | | Elongation | Tensile | Young's |
|---|---|---|---|---|
| | Table | at Break | Strength | Modulus |
| Sample | (Entry) | (%) | (MPa) | (MPa) |
| PE | 1(11) | 306 | 16.7 | 76.3 |
| PE | 1(12) | 702 | 31.6 | 72.1 |
| PE-b-PMA | 4(3) | 414 | 3.08 | 2.42 |
| PE-b-PEA | 4(4) | 371 | 0.63 | 1.13 |
| PE-b-PnBA | 4(5) | 53 | 0.17 | 0.43 |
| PE-b-PtBA | 4(6) | 2.0 | 20.8 | 1600 |
| PE-b-PBzA | 4(7) | 564 | 0.68 | 0.44 |
| PE-b-PMMA | 4(8) | 3.6 | 21 | 1300 |

PE obtained at 15 psi showed a strain at break of 306%, a tensile strength of 16.7 MPa and Young's modulus of 76.3. MPa, while PE produced at 135 psi exhibited a more elastomeric behavior with an elongation break at 702%, a tensile strength of 31.6 MPa and a Youngs modulus of 72.1. The Young's modulus of both PEs showed a similar value and indicated that the material rigidity between both PEs is similar. A more detailed investigation of the mechanical properties by tensile stress testing confirmed the wide range of mechanical behavior of the PE/polyacrylate diblocks. Interestingly, we found that polyacrylate blocks provide not only elastomeric properties, but also hardness and stiffness. For example, the combination of PtBA or PMMA with PE blocks created rigid and hard and rigid copolymers. The PE-b-PMMA exhibited high tensile properties (and Young's modulus) and low deformation, as well as PE-b-PtBA. PE-b-PMA exhibited a strain range up to 414%, strength of 3.08 MPa, and a modulus of 2.42 MPa, but when the acrylate segment was changed to PEA, the strength decreased to 0.63 MPa. The Young's modulus of PE-b-PEA dropped to 1.13 MPa and indicated deformation of PE-b-PEA is more facile than in PE-b-PMA. As for the PnBA and PBzA diblocks, both showed the same moduli, but significant difference in strength and elongation. PE-b-PnBA could only encompass a strain to 53%, but PE-b-PBzA gave elastomeric behavior with a strain at break of 564%.

Cyclic stress-strain experiments were conducted to further test the elastic recovery of prepared crystalline elastomers. After the tensile strain reached 300%, the samples of PE-b-PMA and PE-b-PBzA were unloaded fully, followed by a reloading. The tougher PE-b-PMA sample showed a 92.3% recovery after unloading in contrast to the softer PE-b-PBzA which displayed a recovery of 93.1%.

These selected ethylene/acrylate diblock copolymers demonstrate that their mechanical properties can be tailored to a broad range of properties. To summarize, the blocks can be tuned to exhibit properties of a hard plastic, elastomer, or even semi-amorphous polymers. The crystalline nature of the low branching PE block provides hard and stiff properties and leads to elastomeric materials (PE-b-PMA and PE-b-PBzA) which are comparable to multiblock polyolefin materials.

Electronic and steric characteristics of axial shielding in organometallic α-diimine catalysts are considered to be the key governing factors to develop α-diimine catalysts which either produce amorphous or semi-crystalline polyolefins. Herein, we elucidate the effect of small aliphatic groups, such as methyl groups, at meta or para positions of benzhydryl-derived substituents of the diimine backbone to function as rotation barriers to form catalyst geometries that balance shielding and monomer accessibility of the metal center. The results illustrated that m-xylyl substitutes form a distorted sandwich geometry which provide optimized conditions for a high catalytic activity and inhibition of chain-transfer to lead to the desired linear PE in living polymerizations of up to an hour. The high molecular weight PE is generated by catalyst 1 which has not only a low branching density (<17/1000 C) but also consists solely of methyl branches. In comparison, p-tolyl groups exhibit a more open geometry of catalyst 2 which leads to chain-transfer and non-living polymerizations. Copolymerization of ethylene with MA demonstrated further the profound effect of the two different geometric structures towards the accessibility of polar monomers. Catalyst 1 limits the availability of the catalytic center to MA and yields higher molecular weight ethylene/MA copolymers with a low polar monomer incorporation. In contrast, catalyst 2 incorporates MA more readily which greatly decreases its activity, and lower molecular weight copolymers are produced. The steric demands of catalyst 1 promote an ethylene/acrylate block copolymer formation using the MILRad process without the addition of an ancillary ligand. A series of high molecular weight (˜500 K) block copolymers were generated. Furthermore, it was shown that a post-functionalization of block copolymers is feasible through the incorporation of NAS ester groups, demonstrated with an amine-carrying dye. The nature of the acrylic block could significantly modify the mechanical properties of PE and block copolymers ranging from elastomers to hard plastics were prepared. PE-b-PBzA and PE-b-PMA featured excellent elastomeric properties with high strain break values and elastic recovery which are further tested as additives for high performance plastics requiring strong interface interactions and impact strength.

What is claimed is:

1. A catalyst having a structure according to Formula (1): 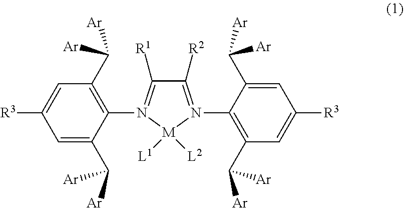
wherein
R¹ and R² are each independently selected from aliphatic groups, substituted or unsubstituted phenyl groups and silyl groups, or R¹ and R² are bonded together in the form of a cycloalkane;
each R³ is hydrogen, an aliphatic group or a halogen;
each Ar group is a meta-substituted phenyl group, a para-substituted phenyl group or a meta- and para-substituted phenyl group;
M is a transition metal; and
L¹ and L² are each independently methyl, Cl, Br, NCCH₃, DMSO, or L¹ and L² are bonded together in the form of a bidentate ligand.

2. The catalyst of claim 1, wherein each Ar group has a structure according to Formula (2): 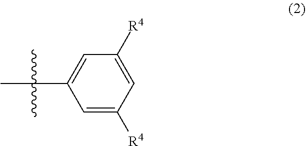
wherein each R⁴ is methyl, tert-butyl, trifluoromethyl, F, or nitrile.

3. The catalyst of claim 2, wherein each R⁴ is methyl.

4. The catalyst of claim 1, wherein each Ar group has a structure according to Formula (3): 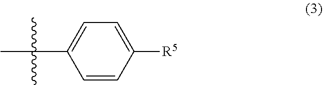
wherein each R⁴ is methyl, ethyl, propyl, isopropyl, butyl, tert-butyl, pentyl, vinyl, ethynyl, 1,1-diofluoroethyl, —CH₂NHCH₃, a benzyl group, trifluoromethyl, trimethylsilyl, ethynyltrimethylsilane, a piperidinyl group, or a morpholino group.

5. The catalyst of claim 4, wherein each R⁵ is methyl.

6. The catalyst of claim 1, wherein each Ar group is 3,4,5-trimethylbenzene, 3,4,5-trifluorobenzene, 4-amino-3,5-dimethylbenzene, 4-amino-3,5-diethylbenzene, or 4-amino-3,5-difluorobenzene.

7. The catalyst of claim 1, wherein L¹ is methyl and L² is Cl or L¹ is Cl and L² is methyl.

8. The catalyst of claim 1, wherein M is Pt, Pd, Ni, Rh, Ti and Ir.

9. The catalyst of claim 1, wherein M is Pd(II) or Ni(II).

10. The catalyst of claim 1, wherein M is Pd(II).

11. A composition comprising a catalyst according to claim 1 and a catalysis promoting salt.

12. The composition of claim 11, wherein the catalysis promoting salt is sodium tetrakis[3,5-bis(trifluoromethyl)phenyl]borate (NBArF) or lithium tetrakis(pentafluorophenyl)borate.

13. A method of forming a polyethylene (PE), the method comprising reacting ethylene monomers with a catalyst according to claim 1.

14. A method of forming a polyethylene (PE), the method comprising reacting ethylene monomers with a composition according to claim 12.

15. A method of forming a polyolefin (PO), the method comprising reacting one or more olefin monomers with a catalyst according to claim 1.

16. A method of forming a polyolefin (PO), the method comprising reacting one or more olefin monomers with a composition according to claim 12.

17. A method of forming a polyethylene/olefin copolymer (P(E-co-O)), the method comprising reacting ethylene monomers and one or more olefin monomers with a catalyst according to claim 1.

18. A method of forming a polyethylene/olefin copolymer (P(E-co-O)), the method comprising reacting ethylene monomers and one or more olefin monomers with a composition according to claim 12.

19. A method of forming a polyethylene/acrylate copolymer (P(E-co-Acrylate)) or a polyethylene/methacrylate copolymer (P(E-co-Methacrylate)), the method comprising reacting ethylene monomers and one or more acrylate monomers or one or more methacrylate monomers with a catalyst according to claim 1.

20. A method of forming a polyethylene/acrylate copolymer (P(E-co-Acrylate)) or a polyethylene/methacrylate copolymer (P(E-co-Methacrylate)), the method comprising reacting ethylene monomers and one or more acrylate monomers or one or more methacrylate monomers with a composition according to claim 12.

21. A method of forming a polyolefin/acrylate copolymer (P(O-co-Acrylate)) or a polyolefin/methacrylate copolymer (P(O-co-Methacrylate)), the method comprising reacting olefin monomers and one or more acrylate monomers or one or more methacrylate monomers with a catalyst according to claim 1.

22. A method of forming a polyolefin/acrylate copolymer (P(O-co-Acrylate)) or a polyolefin/methacrylate copolymer (P(O-co-Methacrylate)), the method comprising reacting olefin monomers and one or more acrylate monomers or one or more methacrylate monomers with a composition according to claim 12.
